(19) United States
(12) Patent Application Publication
(10) Pub. No.: US 2026/0310215 A1
(43) Pub. Date: Oct. 8, 2026

(54) IMPLEMENTING ADAPTIVE ROBOTIC BEHAVIOR WITH REAL-TIME INTENT ESTIMATION

(71) Applicant: Field AI, Inc., Mission Viejo, CA (US)

(72) Inventors: Aliakbar AGHAMOHAMMADI, Mission Viejo, CA (US); David FAN, Lake Forest, CA (US); Muhammad Fadhil GINTING, Aliso Viejo, CA (US); Shayegan OMIDSHAFIEI, Dorchester, MA (US); Dong Ki KIM, Cambridge, MA (US); Amirreza SHABAN, Seattle, WA (US)

(73) Assignee: Field AI, Inc., Mission Viejo, CA (US)

(21) Appl. No.: 19/641,202

(22) Filed: Apr. 7, 2026

Related U.S. Application Data
(60) Provisional application No. 63/784,320, filed on Apr. 7, 2025.

(51) Int. Cl. G05D 1/617; B25J 9/16

(52) U.S. Cl. CPC G05D 1/617; B25J 9/163; G05B 2219/39001; G05B 2219/39151

(57) ABSTRACT

Implementations for adaptive robotic interaction can include predicting expected human behavior or environmental change prior to execution of a robot action, initiating partial execution of the robot action, sensing observed behavior or environmental change during execution, and inferring alignment between predicted and observed states. Based on the inferred alignment, a confidence condition associated with the robot action is evaluated to determine whether execution should continue or be adapted. In some implementations, belief-space representations, semantic perception, and environmental stability prediction are used to improve interaction reliability and safety in dynamic environments.

### CROSS REFERENCE TO RELATED APPLICATIONS

This application claims priority to and the benefit of the filing date of provisional U.S. Patent Application No. 63/784,320, entitled “SYSTEM AND METHOD FOR IMPLEMENTING ADAPTIVE ROBOTIC HANDOFFS WITH REAL-TIME INTENT ESTIMATION” and filed on Apr. 7, 2025, the entire contents of which are hereby expressly incorporated herein by reference.

### TECHNICAL FIELD

The present implementations can relate generally to robotics and autonomous systems and, more particularly, to systems and methods for adaptive robotic interaction using predictive belief-space modeling, semantic perception, and alignment-based decision processes to coordinate robot actions with human behavior and environmental conditions.

### BACKGROUND

Robotic systems are increasingly deployed in environments where they must interact directly with humans and operate within dynamic surroundings. Examples include service robots, delivery robots, inspection robots, and collaborative industrial systems. In these environments, robots must safely coordinate their actions with human behavior and environmental conditions that may change unpredictably. Conventional robotic control approaches typically rely on predetermined motion plans, reactive collision detection, or simple rule-based triggers. These approaches often assume that human behavior and environmental conditions are relatively stable or predictable during execution of a robot action.

However, real-world interactions frequently involve uncertainty. Human participants may change their posture or motion during an interaction, environmental obstacles may move unexpectedly, and contextual conditions may evolve as the robot begins executing a task. Existing robotic systems often respond to these conditions only after they occur, which can result in delayed reactions, aborted interactions, or unsafe behaviors. For example, a robot performing an object handoff may begin an interaction based on an initial observation of human readiness, only to discover mid-execution that the user has moved or that an obstacle has entered the interaction space. As robotic systems are deployed in increasingly complex environments, there is a need for improved techniques that allow robots to anticipate human behavior and environmental change, evaluate correspondence between predicted and observed interaction states, and adapt robot actions accordingly.

### SUMMARY

In accord with one general aspect, described herein is a system having a processor and a memory in communication with the processor, where the memory includes executable instructions that, when executed by the processor, cause the system to perform multiple functions. These functions may include predicting, by one or more processors of a robotic system and prior to execution of a robot action, at least one of an expected human behavior or an expected environmental change associated with a future execution of the robot action, the predicting being performed using a belief-space representation of the human or environment, initiating partial execution of the robot action by the robotic system, and sensing, during the partial execution of the robot action, at least one of an observed human behavior or an observed environmental change using one or more sensors of the robotic system. These functions may further include inferring, by the one or more processors, an alignment between the predicted human behavior or environmental change and the sensed human behavior or environmental change, determining, based on the inferred alignment, whether a confidence condition associated with the robot action is satisfied, and performing at least one of (i) continuing execution of the robot action, based on determining that the confidence condition is satisfied, or (ii) adapting the robot action by modifying at least one of a motion trajectory, timing, force, orientation, communication, or execution sequence of the robot action based on determining that the confidence condition is not satisfied.

In accord with another general aspect the method described herein may involve multiple steps. These steps may include predicting, by one or more processors of a robotic system and prior to execution of a robot action, at least one of an expected human behavior or an expected environmental change associated with a future execution of the robot action, the predicting being performed using a belief-space representation of the human or environment, initiating partial execution of the robot action by the robotic system, and sensing, during the partial execution of the robot action, at least one of an observed human behavior or an observed environmental change using one or more sensors of the robotic system. These steps may further include inferring, by the one or more processors, an alignment between the predicted human behavior or environmental change and the sensed human behavior or environmental change, determining, based on the inferred alignment, whether a confidence condition associated with the robot action is satisfied, and performing at least one of (i) continuing execution of the robot action, based on determining that the confidence condition is satisfied, or (ii) adapting the robot action by modifying at least one of a motion trajectory, timing, force, orientation, communication, or execution sequence of the robot action based on determining that the confidence condition is not satisfied.

In accord with yet another general aspect, the instant disclosure describes a non-transitory computer readable medium on which are stored instructions that when executed cause a programmable device to perform multiple functions. These functions may include predicting, by one or more processors of a robotic system and prior to execution of a robot action, at least one of an expected human behavior or an expected environmental change associated with a future execution of the robot action, the predicting being performed using a belief-space representation of the human or environment, initiating partial execution of the robot action by the robotic system, and sensing, during the partial execution of the robot action, at least one of an observed human behavior or an observed environmental change using one or more sensors of the robotic system. These functions may further include inferring, by the one or more processors, an alignment between the predicted human behavior or environmental change and the sensed human behavior or environmental change, determining, based on the inferred alignment, whether a confidence condition associated with the robot action is satisfied, and performing at least one of (i) continuing execution of the robot action, based on determining that the confidence condition is satisfied, or (ii) adapting the robot action by modifying at least one of a motion trajectory, timing, force, orientation, communication, or execution sequence of the robot action based on determining that the confidence condition is not satisfied.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1A shows an example system for adaptive robotic interaction.

FIG. 1B illustrates the system 100 of FIG. 1A implementing a Semantic Belief Behavior Graph (SB2G) framework.

FIG. 2A depicts an example architecture in which the methods of FIGS. 3-8 of the present implementations may operate.

FIG. 2B is a block diagram showing an example system of the architecture of FIG. 2A along with its corresponding subsystems.

FIG. 3 shows an example method for adaptive robotic interaction.

FIG. 4 is an example method 400 of adaptive robot interaction that further includes a prediction of environmental stability.

FIG. 5 is an example method of adaptive robot interaction as in FIGS. 3, 4, and 7 that further includes an active semantic search and belief-space update process.

FIG. 6 illustrates substeps that may be performed as part of the predicting step of the methods of FIGS. 3-5 and 7.

FIG. 7. is an example method of adaptive robot interaction as in FIGS. 3-5 that further includes an interaction outcome recording and prediction-accuracy learning process.

FIG. 8 illustrates substeps that may be performed as part of the inferring and determining steps of the methods of FIGS. 3-5 and 7.

FIG. 9 is a block diagram illustrating an example software architecture, various portions of which may be used in conjunction with various hardware architectures herein described, which may implement any of the above-described features.

FIG. 10 is a block diagram illustrating components of an example machine configured to read instructions from a machine-readable medium (for example, a machine-readable storage medium) and perform any of the features described herein.

### DETAILED DESCRIPTION

In the following detailed description, numerous specific details are set forth by way of examples in order to provide a thorough understanding of the relevant teachings. It will be apparent to persons of ordinary skill, upon reading this description, that various aspects can be practiced without such details. In other instances, well known methods, procedures, components, and/or circuitry have been described at a relatively high-level, without detail, in order to avoid unnecessarily obscuring aspects of the present teachings.

### Technical Problem

Robot interactions with humans and the environment, such as robotic package handoffs in real-world environments, can present a technical challenge that existing systems fail to adequately address. Conventional robotic handoff approaches rely on predefined trajectories, static grasp strategies, or simple proximity and gesture-based triggers. These techniques assume predictable user behavior and stable surroundings, which can make them inadequate when confronted with occlusions, last-moment user motion, weak or misaligned grips, or dynamic environmental obstacles. Known feedback mechanisms can improve safety but operate reactively and lack the ability to anticipate intent or adapt strategies before physical contact occurs. Additionally, existing semantic planning frameworks focus primarily on navigation, inspection, or task allocation and do not govern fine-grained physical interaction with humans or real-world environments. As a result, robots are unable to reason about human or environmental readiness, uncertainty in semantic perception, or confidence thresholds required to safely transition between behaviors during an object exchange. This disconnect between high-level semantic reasoning and low-level manipulation can lead to failed handoffs, dropped packages, and safety risks, particularly in crowded or unstructured environments such as last-mile delivery settings. Therefore, a technical problem exists in enabling robots to dynamically infer human intent and environmental uncertainty and to adapt physical behavior, such as handoff behavior, in real time.

### Technical Solution

The disclosed implementations solve the technical problem by introducing adaptation that integrates real-time intent estimation, semantic uncertainty management, and closed-loop physical control. The implementations can be configured with belief-space representations and theory-of-mind principles to predict human behavior or environmental change based on a future robot action, sense human behavior and environmental change based on partial execution of the action, infer alignment between the predicted and sensed behavior or change, and either continue with the robot action or adapt it based on the alignment. In a handoff context, this can include inferring human readiness, grip alignment, and engagement timing prior to initiating a handoff, and adjusting a robot's handoff procedure accordingly. This predictive modeling can provide that the robot to proactively adjusts behavior rather than relying on reactive corrections. In some implementations, a semantic detection subsystem continuously analyzes multimodal sensor data relating to including posture, hand position, motion patterns, and environmental context to manage dynamic behavior switching. An obstacle detecting subsystem can perform an active semantic search to reduce uncertainty and enforce confidence-based transitions between handoff states, enabling the robot to pause, recalibrate, or abort a transfer when unsafe conditions are detected. In some implementations, during a handoff, a package transferring subsystem can dynamically adjust grip strength, orientation, approach trajectory, and release timing based on real-time feedback from the belief and semantic subsystems, utilizing the alignment between predicted and sensed behavior. Post-handoff outcomes can be recorded to refine future predictions. Together, these components bridge semantic reasoning and physical manipulation, enabling safe, robust, and natural human-robot-environment interactions in unpredictable environments.

As used herein, a “vector” may refer to a structured data element comprising an ordered or associated set of machine-readable values that collectively represent attributes of an entity, observation, action, or state within a robotic interaction system. A vector may include numeric values, identifiers, Boolean values, categorical labels, sensor-derived measurements, probabilistic values, or other structured data elements. The ordering of elements within the vector may be positional, keyed, schema-defined, or otherwise logically associated. Vectors may be stored, transmitted, or processed using various data representations, including relational database records, structured objects, key-value collections, serialized messages, sensor data structures, or state variables maintained within robotic control software. In some implementations, vectors encode logically related attributes associated with sensed observations, predicted behaviors, or robot actions. For example, a sensor observation vector may encode features derived from cameras, lidar, or depth sensors; a human behavior vector may represent estimated posture, orientation, or motion trajectory of a human participant; and an action vector may represent parameters describing a candidate robot interaction such as trajectory, orientation, timing, or force characteristics. The term vector is used herein in a generalized computational sense and does not require implementation as a mathematical vector or linear-algebra structure.

As used herein, a “tensor” may refer to a composite data structure comprising a collection of vectors, fields, or substructures that together represent a multidimensional state representation of an environment, interaction state, or belief-space representation within a robotic interaction system. A tensor may organize related vectors along defined schema dimensions and may include nested structures, indexed collections, relational references, or hierarchical records. For example, a belief-state tensor associated with a robot interaction may include vectors representing predicted human behavior, environmental conditions, robot state parameters, and semantic observations derived from sensor data. The tensor may further include substructures encoding probabilistic distributions associated with candidate interaction states such as human readiness, environmental stability, or obstacle proximity. In some implementations, the tensor may also include parameters describing predicted transitions between states based on candidate robot actions. A tensor therefore functions as a unified representation of the predicted and observed state of an interaction environment at a given time. The tensor may be implemented using various storage mechanisms, including relational database tables, structured application objects, document-oriented records, graph-based data structures, or memory-resident state objects within robotic control software. The term tensor is used herein to describe a structured, multi-component state representation and does not require implementation using formal tensor algebra or machine-learning frameworks.

As used herein, a “graph” may refer to a structured computational representation comprising a set of nodes connected by edges that represent relationships, transitions, or dependencies between states, actions, or semantic entities within a robotic interaction system. A graph may encode structural or probabilistic relationships among multiple components of an interaction environment, enabling the system to reason about possible state transitions or behavioral sequences. Graphs may be stored, transmitted, or processed using various data representations, including adjacency matrices, adjacency lists, relational tables, structured objects, or graph databases. In some implementations, a graph may represent a semantic belief behavior graph in which nodes correspond to interaction states or behaviors and edges represent transitions between those states based on observed conditions or predicted outcomes. For example, edges within the graph may represent transitions between behaviors such as search, inspection, navigation, or object transfer operations. The term graph is used herein in a generalized computational sense to denote a structured representation of relationships or transitions among system states and does not require implementation using any particular graph-processing framework or graph-theoretic algorithm.

As used herein, a “node” may refer to an individual computational element within a graph that represents a state, entity, behavior, or observation associated with a robotic interaction system. A node may include one or more fields, vectors, tensors, or associated metadata describing attributes or conditions associated with the represented state or entity. Nodes may be instantiated, stored, transmitted, or updated by processors within the robotic system and may be implemented using a variety of representations, including structured objects, database records, serialized data structures, or memory-resident data elements. In some implementations, nodes within a semantic belief behavior graph may represent interaction states such as environmental search operations, inspection behaviors, navigation tasks, or object transfer operations. Nodes may also represent semantic entities detected in the environment, such as obstacles, objects of interest, or human participants. The term node is used broadly to describe a machine-readable computational element representing a state or entity within a graph structure and does not require implementation using any particular graph-processing architecture or programming paradigm.

As used herein, a “belief-space representation” may refer to a structured computational model that encodes probabilistic estimates of one or more states of a system, environment, or interacting entity based on available observations and predictive inference. A belief-space representation may include probability distributions, confidence values, or weighted state estimates associated with candidate system states, behavioral states, or environmental conditions. A belief-space representation may be constructed from sensor observations, contextual information, historical interaction data, or predictive models executed by processors of a robotic system. In some implementations, the belief-space representation encodes probabilistic estimates of human behavioral states, environmental conditions, or robot interaction readiness. For example, a belief-space representation may encode candidate states such as human readiness to receive an object, uncertainty in engagement, approach trajectory of a human participant, or environmental stability within an interaction region. The belief-space representation may be implemented using vectors, tensors, probability distributions, or other structured data representations maintained within memory of a robotic system. The representation may be continuously updated as new observations are obtained from sensors such as cameras, lidar systems, depth sensors, or motion detectors. By maintaining probabilistic estimates of possible system states, the belief-space representation can allow the robotic system to reason about uncertain conditions and to predict how those conditions may evolve during execution of a robot action. The term belief-space representation is used herein in a generalized computational sense and does not require implementation using any particular probabilistic framework, filtering technique, or machine-learning architecture.

As used herein, an “alignment metric” may refer to a quantitative or qualitative measure that represents a degree of correspondence between a predicted state and an observed state within a robotic interaction system. The alignment metric may be computed by comparing predicted behavioral or environmental conditions generated by a predictive model with actual observations obtained from sensors during execution of a robot action. Inputs used to compute the alignment metric may include predicted behavior vectors, predicted environmental state tensors, sensor observation vectors, or belief-space representations describing the current observed state of the environment or a human participant. The resulting metric may represent how closely predicted and observed states correspond. For example, an alignment metric may indicate whether a predicted human response to a robot action matches the observed posture, motion trajectory, or engagement behavior of a human participant. The alignment metric may be represented as a numerical score, probability value, confidence indicator, or other structured data element describing the degree of correspondence between predicted and observed states. In some implementations, the metric may be evaluated against one or more thresholds to determine whether execution of a robot action should continue or be modified. The term alignment metric is used broadly to denote any measure of correspondence between predicted and observed states and does not require implementation using a specific statistical measure or similarity function.

As used herein, a “divergence metric” may refer to a quantitative measure that represents a degree of difference between two state representations, such as a predicted state distribution and an observed state distribution within a belief-space representation. The divergence metric may characterize the magnitude of discrepancy between predicted and observed conditions associated with a robotic interaction. Inputs used to compute the divergence metric may include probability distributions, vectors, tensors, or other structured state representations generated by predictive models and perception modules of a robotic system. For example, a predicted state distribution may represent expected human behavior or environmental conditions associated with a planned robot action, while an observed state distribution may represent sensor-derived measurements obtained during execution of that action. The divergence metric may be computed using statistical distance measures, similarity functions, or other comparison techniques that evaluate differences between the predicted and observed distributions. In some implementations, the divergence metric may quantify differences in probability values associated with candidate behavioral or environmental states within a belief-space representation. The resulting divergence metric may be represented as a numerical value, score, or vector indicating the magnitude of difference between predicted and observed states. This metric may be used by decision processes within the robotic system to determine whether predicted interaction outcomes remain sufficiently accurate to permit continued execution of a robot action. The term divergence metric is used herein in a generalized computational sense and does not require implementation using any particular statistical divergence formulation.

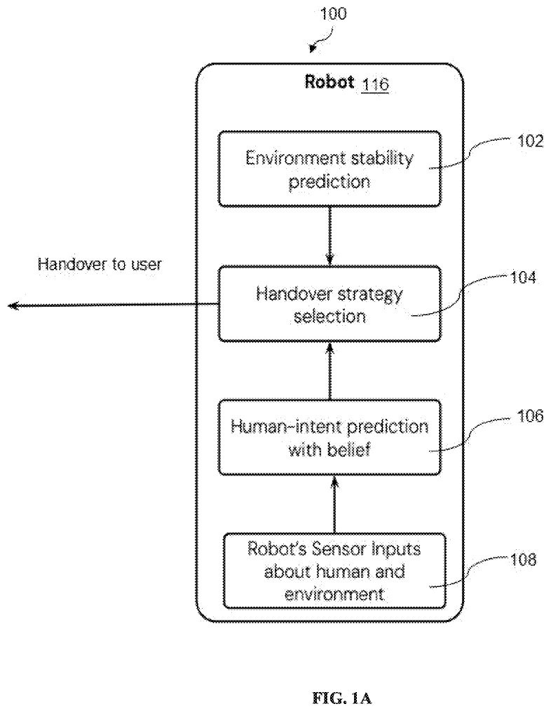

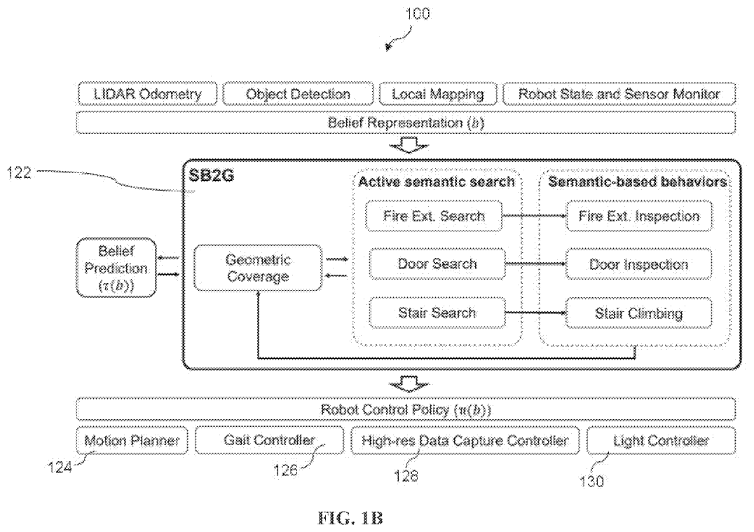

FIG. 1A shows an example system 100 for adaptive robotic interaction implemented by a robot 116 configured to perform controlled object exchanges with a user in a dynamic environment. The system 100 enables the robot 116 to evaluate environmental conditions and predicted human intent before and during execution of an interaction action, such as a package handoff. Through the integration of predictive modeling, belief-based reasoning, and real-time sensor feedback, the system 100 allows the robot 116 to dynamically select and adapt interaction strategies in response to changing human behavior and environmental conditions. As shown, the robot 116 can receive input from a plurality of sensor inputs 108 relating to both the human participant and the surrounding environment. These sensor inputs may be provided by one or more sensing modalities, including but not limited to vision sensors, depth cameras, lidar, proximity sensors, force sensors, tactile sensors, microphones, inertial sensors, or other sensing components capable of detecting environmental and human-state information. The sensor inputs 108 can provide observations relating to factors such as human posture, hand position, motion trajectory, grip orientation, surrounding obstacles, crowd movement, and other environmental conditions that may affect the safety or feasibility of an interaction. Information derived from the sensor inputs 108 can be provided to a human-intent prediction module 106, which can generate a belief-based representation of the user's likely behavior or readiness for interaction. In some implementations, the human-intent prediction module 106 can utilize a belief-space model that represents multiple possible human states and their associated probabilities. This belief-space representation may incorporate theory-of-mind modeling or probabilistic inference techniques to estimate whether a user intends to receive an object, how the user is likely to move in response to the robot's action, and whether the user's posture or hand position indicates readiness for engagement. For example, the human-intent prediction module 106 may determine whether the user's hand is positioned to receive a package, whether the user's motion suggests approach or withdrawal, or whether the user's body orientation indicates attention toward the robot. These predictions enable the system to anticipate the human response to a forthcoming robotic action rather than merely reacting after contact occurs.

In parallel with the prediction of human intent, the system 100 can perform an environment stability prediction 102, which evaluates whether the surrounding environment is likely to remain sufficiently stable for safe execution of the interaction. The environment stability prediction module 102 analyzes the same or additional sensor inputs 108 to estimate potential environmental changes that may affect the interaction. These may include the movement of nearby individuals, the presence of obstacles, environmental disturbances, or other contextual changes that could interfere with the robot's planned motion. The environment stability prediction module 102 may compute a stability metric representing the likelihood that the environment will remain within a predefined safety envelope during execution of the robot action. For example, the module may determine whether a passerby is approaching the interaction zone, whether an object may obstruct the robot's path, or whether the environment contains unpredictable motion that could cause a failed handoff. In this way, the system accounts not only for human readiness but also for environmental dynamics that may impact the interaction. Machine learning models may be incorporated into the environment stability prediction module 102. In this context, models may encode environmental observations and robot trajectory parameters into feature representations describing the dynamic state of the environment. These encoded features may then be decoded into stability metrics indicating whether environmental conditions are likely to remain within a predefined safety envelope during execution of a robot action. Outputs from both the human-intent prediction module 106 and the environment stability prediction module 102 can be provided to a handover strategy selection module 104. The handover strategy selection module 104 can determine how the robot 116 should perform the interaction based on the predicted human behavior and environmental stability conditions. The module 104 may select from multiple possible handover strategies, each representing a different approach for executing the robot action. For example, strategies may include extending the object toward the user at different orientations, adjusting the speed or trajectory of the robot's motion, delaying the interaction until environmental conditions stabilize, or selecting an alternate interaction posture. The handover strategy selection module 104 may incorporate machine learning models that encode interaction context, including predicted human behavior, environmental stability indicators, and robot state information, into decision features used to select an interaction strategy. From these encoded representations, the system may decode a selected interaction policy, motion trajectory, or execution strategy that is predicted to result in a successful and safe interaction. The handover strategy selection module 104 may also utilize confidence thresholds derived from the belief-space representation and stability prediction to determine whether the interaction should proceed. If both the predicted human intent and environmental stability satisfy defined conditions, the robot 116 may initiate or continue the handover. Conversely, if predicted conditions indicate uncertainty or instability, the system may adapt the planned action by modifying the robot's trajectory, adjusting timing, or temporarily postponing the interaction. For example, if the system predicts that a user's grip is misaligned or that a passerby may interfere with the handoff, the robot 116 may reposition the object, pause the interaction, or select a safer strategy. In operation, the components of the system 100 can provide that the robot 116 can implement a predictive interaction control framework in which anticipated responses from both the human participant and the environment influence the execution of robot actions. Rather than relying solely on reactive feedback, the system can iteratively predict likely outcomes, evaluate observed conditions through sensor inputs, and select appropriate strategies for executing the interaction. This approach improves the robustness and safety of robotic interactions, particularly in dynamic or uncertain environments where human behavior and environmental conditions may change rapidly.

FIG. 1B illustrates the system 100 of FIG. 1A implementing a Semantic Belief Behavior Graph (SB2G) framework 122 that may enable a robot to reason about semantic information, reduce uncertainty in an environment, and select appropriate behaviors for interaction and inspection tasks. The SB2G framework 122 may operate as an intermediate reasoning layer that receives perceptual and state information, maintains a belief representation of the environment, and produces a robot control policy π(b) that may govern execution of robot behaviors. The system 100 may receive a plurality of perceptual and state inputs that can be used to construct a belief representation b of the environment. These inputs may include, for example, LIDAR odometry, object detection, local mapping, and robot state and sensor monitoring. LIDAR odometry may provide estimates of robot motion and position relative to the environment. Object detection may identify objects or semantic targets of interest, such as doors, fire extinguishers, or stairways. Local mapping may generate a spatial representation of the surrounding environment, which may include obstacle locations or traversable regions. Robot state and sensor monitoring may track internal robot conditions, sensor outputs, and environmental observations. Together, these inputs may be integrated into the belief representation b, which may represent probabilistic knowledge about the environment and the presence or location of semantic targets. The belief representation b may be provided to the SB2G framework 122, which may include a belief prediction module τ(b) and a set of behavior-selection components. The belief prediction module τ(b) may predict how the belief state may evolve as the robot performs actions in the environment. For example, τ(b) may estimate how the probability of detecting a target object may change as the robot moves to new locations or gathers additional observations. In this way, the SB2G framework may reason about both the current belief state and the expected evolution of that belief state under potential robot actions. Within the SB2G framework 122, the system may include a geometric coverage module that may determine regions of the environment that the robot may explore in order to increase confidence in the belief representation. The geometric coverage module may guide the robot toward unexplored areas or areas with high uncertainty, enabling the robot to gather additional observations that may refine the belief representation.

The SB2G framework 122 may further include an active semantic search layer that may generate search behaviors directed toward specific semantic targets. For example, the system may include behaviors such as fire extinguisher search, door search, and stair search. Each search behavior may guide the robot toward locations where the corresponding object or feature may be expected to appear. During execution of a search behavior, the robot may collect sensor data that may increase confidence in the belief representation regarding the presence or absence of the target object. In addition to the active search behaviors, the SB2G framework may include a set of semantic-based behaviors that may be executed once a semantic target has been sufficiently identified. These behaviors may include, for example, fire extinguisher inspection, door inspection, and stair climbing. Each semantic-based behavior may correspond to a specific interaction or inspection task that may be performed when the belief state indicates that the corresponding semantic feature is present with sufficient confidence. Transitions between behaviors within the SB2G framework may be governed by edges in the semantic belief behavior graph. These transitions may depend on belief-state conditions, sensor observations, or predicted belief evolution. For example, when the belief representation indicates a high probability of a door being present, the system may transition from a door-search behavior to a door-inspection behavior. Conversely, if search observations reduce confidence in the belief state, the system may transition back to an exploratory behavior to gather additional information. The SB2G framework 122 may output a robot control policy π(b) that may determine the robot's next action based on the belief representation. The robot control policy may be provided to one or more control components, including a motion planner 124, a gait controller 126, a high-resolution data capture controller 128, and a light controller 130. The motion planner 124 may generate trajectories for robot movement. The gait controller 126 may regulate locomotion or posture control for mobile robotic platforms. The high-resolution data capture controller 128 may manage sensors that collect detailed inspection data, such as cameras or specialized sensing devices. The light controller 130 may adjust illumination to improve visibility during inspection or search tasks. The SB2G framework 122 may also incorporate machine learning components for belief prediction and semantic search. For example, models may encode the belief representation b, which aggregates sensor observations, object detections, and environmental state information, into a latent belief-space representation. From this representation, the system may decode predicted belief transitions or action policies that guide exploration or task execution behaviors. Such models may enable the system to learn relationships between environmental observations and effective robot behaviors for tasks such as search, inspection, or interaction. Thereby, the SB2G framework 122 may enable the robot to reason about semantic targets, actively reduce uncertainty in its environment, and select behaviors that balance exploration and task execution. By integrating belief prediction, active semantic search, and semantic-based behaviors within a unified graph structure, the system may dynamically adapt robot actions based on evolving environmental knowledge and sensor observations.

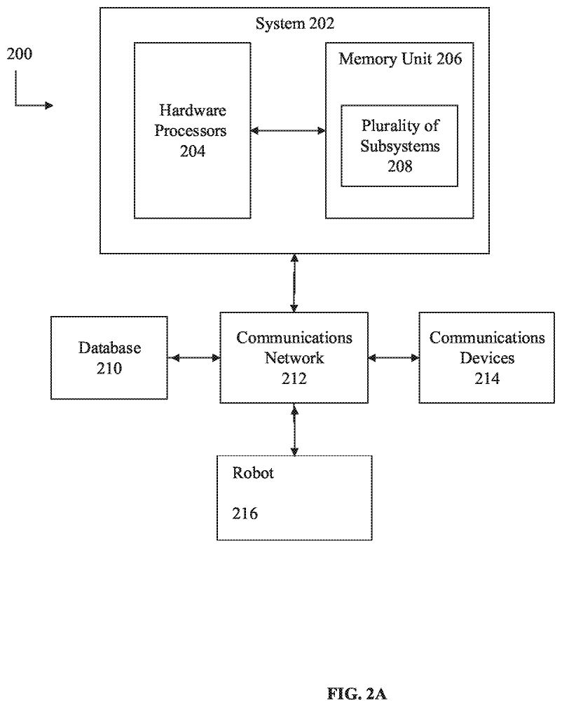

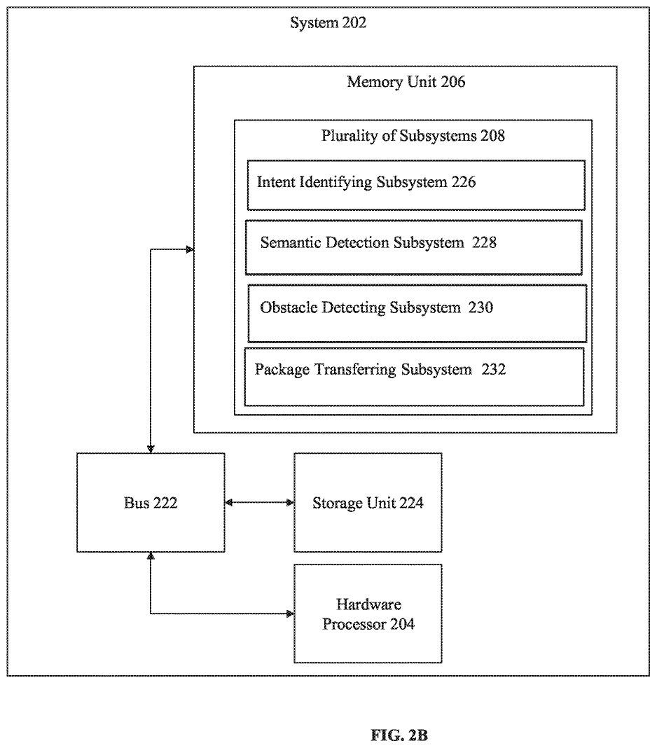

FIG. 2A depicts an example architecture 200 in which the methods of FIGS. 1-3 of the present implementations may operate. The architecture 200 can include a system 202, database 210, communications network 212, communications devices 214, and a robot 216. The system 202 can include hardware processors 204 and a memory unit 206.

The architecture 200 can include a system 202 that includes a hardware processor 204. The one or more hardware processors 204, as used herein, means any type of computational circuit, such as, but not limited to, a microprocessor unit, microcontroller, complex instruction set computing microprocessor unit, reduced instruction set computing microprocessor unit, very long instruction word microprocessor unit, explicitly parallel instruction computing microprocessor unit, graphics processing unit, digital signal processing unit, or any other type of processing circuit. The one or more hardware processors 204 may also include embedded controllers, such as generic or programmable logic devices or arrays, application-specific integrated circuits, single-chip computers, and the like.

The memory unit 206 can include a plurality of subsystems 208. The memory unit 206 may be the non-transitory volatile memory and the non-volatile memory. The memory unit 206 may be coupled to communicate with the one or more hardware processors 204, such as being a computer-readable storage medium. The one or more hardware processors 204 may execute machine-readable instructions and/or source code stored in the memory unit 206. A variety of machine-readable instructions may be stored in and accessed from the memory unit 206. The memory unit 206 may include any suitable elements for storing data and machine-readable instructions, such as read-only memory, random access memory, erasable programmable read-only memory, electrically erasable programmable read-only memory, a hard drive, a removable media drive for handling compact disks, digital video disks, diskettes, magnetic tape cartridges, memory cards, and the like. In the present embodiment, the memory unit 206 can include the plurality of subsystems 208.

The plurality of subsystems 208 can be stored in the form of machine-readable instructions on any of the above-mentioned storage media and may be in communication with and executed by the one or more hardware processors 204. A computer system (standalone, client or server computer system) configured by an application may constitute a “module” (or “subsystem”) that is configured and operated to perform certain operations. In one embodiment, the “module” or “subsystem” may be implemented mechanically or electronically, so a module can include dedicated circuitry or logic that is permanently configured (within a special-purpose processor) to perform certain operations. In another embodiment, a “module” or “subsystem” may also include programmable logic or circuitry (as encompassed within a general-purpose processor or other programmable processor) that is temporarily configured by software to perform certain operations. Accordingly, the term “module” or “subsystem” should be understood to encompass a tangible entity, be that an entity that is physically constructed permanently configured (hardwired) or temporarily configured (programmed) to operate in a certain manner and/or to perform certain operations described herein.

The architecture 200 can include a database 210. The database 210 may include, but is not limited to, storing and managing data related to robot operations, sensor observations, environmental conditions, and interaction states associated with robot 216. The database 210 can serve as a central repository for cross-referencing environmental observations, belief representations, semantic detections, and interaction parameters maintained by system 202 and its subsystems 208. The database 210 can include structured and unstructured data supporting operation of the system 202, including sensor observation records (such as environmental state vectors, detected human posture attributes, motion trajectories, and interaction readiness indicators), belief-state parameters, and environmental stability indicators generated during operation of the system.

In some embodiments, the database 210 stores interaction and environment-related data, including sensor timestamps, detected semantic objects, obstacle identifiers, environmental stability metrics, and predicted human-intent indicators generated by the intent identifying subsystem 226, semantic detection subsystem 228, and obstacle detecting subsystem 230. The database 210 may further maintain historical interaction records, prior belief-state updates, strategy-selection outcomes, and interaction execution logs associated with robotic actions such as object transfers or handoff procedures. During operation, system 202 may write updated sensor observations, belief representations, environmental predictions, and interaction outcomes received via communications network 212 to the database. The system may retrieve stored belief parameters, environmental condition records, or prior interaction outcomes to evaluate interaction readiness and support adaptive decision-making within the subsystems 208. The database 210 may also store audit records, sensor data archives, timestamped state snapshots, and validation artifacts used for monitoring, diagnostics, or system evaluation. In this implementation, the database functions as a persistent and authoritative data repository that supports belief-state maintenance, interaction strategy evaluation, environmental condition monitoring, and verifiable continuity of robot interaction data within the system. The architecture 200 can include a communications network 212. The communications network 212 can include one or more communications networks 212 and can be, but not limited to, a wired communication network, a wireless communication network, or a combination of wired communication networks and wireless communications networks. The wired communication network may include, but not be limited to, at least one of: Ethernet connections, Fiber Optics, Power Line Communications (PLCs), Serial Communications, Coaxial Cables, Quantum Communication, Advanced Fiber Optics, Hybrid Networks, and the like. The wireless communication network may include, but not be limited to, at least one of: wireless fidelity (wi-fi), cellular networks (including 4G (fourth generation), 5G (fifth generation), and 6G (sixth generation) networks), Bluetooth, ZigBee, long-range wide area network (LoRaWAN), satellite communication, radio frequency identification (RFID), advanced IoT protocols, mesh networks, non-terrestrial networks (NTNs), near field communication (NFC), and the like. The communication networks 212 can be configured to facilitate data exchange and communication between the system 202 and the database 210 for real-time data analysis.

The architecture 200 can include communications devices 214. The communications devices 214 can be one or more communication devices 214 and may represent various network endpoints, such as, but not limited to, user devices, mobile devices, smartphones, Personal Digital Assistants (PDAs), tablet computers, phablet computers, wearable computing devices, Virtual Reality/Augmented Reality (VR/AR) devices, laptops, desktops, display interface panels, control panels, human machine interface panels, liquid crystal display (LCD) screens, light-emitting diode (LED) screens, and the like. The one or more communication devices 214 can be configured to function as an intermediate unit between the system 202 and one or more users. The one or more communication devices 214 can be equipped with a user interface that allows the one or more users to interact with the system 202. The user interface may include graphical displays, touchscreens, voice recognition, and other input/output mechanisms that facilitate easy access to data and control functions.

The architecture 200 can include the robot 216. The robot 216 may be implemented as an autonomous or semi-autonomous robotic platform configured to perform adaptive interactions with one or more users and the surrounding environment. In some implementations, the robot 216 operates as the physical execution component of the system 202, performing sensing, decision-informed motion, and interaction actions such as object transfer or handoff procedures. The robot 216 can be implemented as a mobile robotic system operating on wheeled, tracked, or legged locomotion platforms, although other implementations may include stationary robotic manipulators or hybrid robotic systems. The robot 216 is distinct from the computational components of the system 202 and functions as the actuator-driven entity that executes interaction strategies determined by the subsystems 208. The robot 216 can include a sensing and interaction subsystem including one or more sensors configured to capture environmental and human-state observations. These sensors may include cameras, depth sensors, lidar systems, proximity sensors, tactile sensors, force sensors, microphones, and other environmental sensing devices. Sensor outputs may encode environmental-state observations, human posture indicators, motion trajectories, interaction readiness signals, and obstacle detections. The robot 216 may further include actuation components such as robotic arms, manipulators, grippers, locomotion actuators, and communication interfaces configured to perform physical interactions and controlled motion within an environment. In some implementations, the robot 216 includes execution logic configured to receive control instructions from system 202, apply motion trajectories, adjust grip parameters, and perform interaction sequences determined by the subsystems 208.

During operation, the robot 216 can receive control commands, interaction strategies, and motion plans generated by system 202 via the communications network 212. The robot 216 may execute robotic actions such as navigating through an environment, positioning an object for transfer, adjusting orientation or grip force, and completing interaction procedures with a user. The robot 216 may transmit sensor observations, environmental updates, and interaction outcome data back to system 202 for belief-state updates and decision refinement. The robot 216 may further maintain local execution logs, sensor records, and timestamped interaction events that support monitoring, diagnostics, and system evaluation. In some implementations, the robot 216 functions as the physical interaction agent that synchronizes sensor-driven perception with adaptive action execution, ensuring that predictive interaction strategies generated by system 202 are reliably implemented in real-world environments.

FIG. 2B is a block diagram showing an example system of the architecture of FIG. 2A along with its corresponding subsystems. The system 202 can include a memory unit 206, bus 222, storage unit 224, and hardware processor 204. The memory unit 206 can include a plurality of subsystems 208, which can include an intent identifying subsystem 226, semantic detection subsystem 228, an obstacle detecting subsystem 230, and a package transferring subsystem 232.

The system 202 can include a memory unit 206. The memory unit 206 can be identical to the memory unit 206 described in FIG. 2A, and for the sake of brevity, is not described further here. The system 202 can include a bus 222. The system bus 222 can function as a central conduit for data transfer and communication between the one or more hardware processors 204, the memory unit 206, and the storage unit 224. The system bus 222 facilitates the efficient exchange of information and instructions, enabling a coordinated operation of the system 202. The system bus 222 may be implemented using various technologies, including, but not limited to, parallel buses, serial buses, or high-speed data transfer interfaces such as, but not limited to, at least one of a: universal serial bus (USB), peripheral component interconnect express (PCIe), and similar standards.

The system 202 can include a storage unit 224. The storage unit 224 may be a cloud storage or the database 210, such as those shown in FIG. 2A. The storage unit 224 may store, but not limited to, recommended course of action sequences dynamically generated by the system 202. These action sequences can include data-obtaining, data processing, instruction interpreting, adaptive, and the like. The storage unit 224 may be any kind of database such as, but not limited to, relational databases, dedicated databases, dynamic databases, monetized databases, scalable databases, cloud databases, distributed databases, any other databases, graph databases, vector databases, and a combination thereof.

The system 202 can include an intent identifying subsystem 226. The intent identifying subsystem 226 can function as the predictive reasoning component that estimates the likely behavior or readiness of a human participant during a robotic interaction. The intent identifying subsystem 226 can be the structured belief inference authority that defines, at any given moment, the system's probabilistic assessment of whether and how a user intends to engage with the robot. Rather than relying solely on immediate sensor observations or simple gesture detection, the subsystem can explicitly model human behavior within a belief-space representation that evolves as new observations are received. The identifying subsystem 226 can include a human-intent belief representation, which may encode a set of candidate human states and associated probabilities. Each candidate state may correspond to a particular interaction condition, such as readiness to receive an object, uncertainty in engagement, or withdrawal from interaction. These belief states can be continuously updated using observations provided by sensors associated with robot 216 and processed through the semantic detection subsystem 228. The subsystem can interpret observed signals such as hand position, body posture, motion trajectory, orientation toward the robot, or other contextual cues that may indicate a user's intent to interact. The intent identifying subsystem 226 can maintain structured intent parameters that may include a readiness indicator, an engagement probability, and a predicted response vector describing how the human participant may respond to a proposed robot action. The readiness indicator can represent whether a user's posture, orientation, or motion suggests preparedness to receive an object or otherwise participate in an interaction. The engagement probability can represent the subsystem's confidence that the user intends to interact with the robot. The predicted response vector can estimate how the user may move or react as the robot begins to execute a planned action, such as extending an object toward the user. By representing these attributes within a belief structure, the intent identifying subsystem 226 can support probabilistic reasoning about human behavior rather than relying on deterministic triggers. The intent identifying subsystem 226 can also incorporate predictive reasoning that may evaluate how a user is expected to respond to a future robot action. In some implementations, the subsystem can simulate or estimate potential human responses to candidate robot behaviors and update the belief representation accordingly. For example, the subsystem may predict whether a user's hand trajectory will intersect with an object presented by the robot or whether the user may reposition to receive the object. These predictions can provide the system with anticipatory awareness of interaction outcomes before the robot fully commits to an action. The intent identifying subsystem 226 can further maintain confidence thresholds associated with the inferred intent state. These thresholds may determine whether the predicted human behavior is sufficiently aligned with the expected response required for a particular interaction strategy. When confidence conditions are satisfied, the system may permit downstream components, such as the package transferring subsystem 232, to proceed with execution of the robot action. Conversely, when predicted intent confidence falls below a threshold, the system may signal other subsystems to modify or delay the interaction. Within the intent identifying subsystem 226, machine learning models may be used to infer human intent and predict likely human responses to a robot action. For example, neural networks may encode multimodal observation data, such as human posture vectors, hand position coordinates, body orientation features, motion trajectories, and contextual environmental attributes, into a latent human-intent representation. From this encoded representation, the model may decode predicted engagement states, such as readiness to receive an object, uncertainty in engagement, or disengagement from interaction. In some implementations, the model may also decode predicted motion trajectories or behavioral transitions representing how a human participant may respond when a robot initiates a candidate action. By maintaining a continuously updated belief-space model of human readiness and predicted interaction behavior, the intent identifying subsystem 226 can provide the decision foundation for adaptive robotic interaction. Rather than reacting only to completed human motions, the subsystem can estimate and anticipate human intent, enabling the system 202 to coordinate robot actions with predicted human behavior. In this way, the intent identifying subsystem 226 can function as the predictive interaction inference engine that governs how system 202 interprets human engagement and prepares for adaptive robot responses.

In an example implementation, the intent identifying subsystem 226 can function as the predictive inference module that generates a structured human-intent belief tensor representing the estimated interaction readiness of a human participant. The intent identifying subsystem 226 can operate as the semantic belief generator that defines, at any given moment, the system's probabilistic interpretation of human engagement state in response to a proposed robot action. Rather than relying solely on discrete gesture triggers or threshold-based sensor readings, the subsystem can construct and maintain a continuously updated belief-state tensor derived from multimodal perception inputs and interaction context vectors. The intent identifying subsystem 226 can include a human-intent state tensor, indexed by a human interaction vector that encodes candidate behavioral states and associated probability weights. Each element of the tensor may correspond to a predicted engagement condition such as ready-to-receive, uncertain engagement, approach trajectory, or interaction withdrawal. These values can be updated using observation vectors derived from sensors associated with robot 216 and semantic features detected by the semantic detection subsystem 228. The subsystem can map observed posture vectors, hand-position coordinates, body-orientation vectors, and motion trajectories into the belief tensor to update probability distributions associated with candidate human states.

The intent identifying subsystem 226 can maintain structured intent-state vectors including a readiness vector, an engagement probability vector, and a predicted response tensor describing the anticipated response of the human participant to a future robot action. The readiness vector may encode posture alignment, limb positioning, and orientation features associated with interaction readiness. The engagement probability vector may represent the probability distribution across potential interaction states. The predicted response tensor may represent estimated human motion trajectories or behavioral transitions that may occur if the robot initiates a candidate interaction action, such as extending an object toward the user. In some implementations, the subsystem can generate an action-conditioned prediction tensor that estimates how the human state distribution may evolve when a proposed robot action vector is applied. This action-conditioned tensor may represent expected human response trajectories as a function of the planned robot action parameters, such as motion trajectory, object orientation, or approach velocity. By constructing this predictive tensor, the subsystem can evaluate potential human responses prior to full execution of the robot action. The intent identifying subsystem 226 can also compute a belief-alignment metric tensor representing the degree of correspondence between predicted human response states and observed sensor-derived state vectors during partial execution of a robot action. This alignment tensor can be evaluated against predefined confidence thresholds stored within the belief representation. When the alignment metric satisfies the required confidence condition, the subsystem can signal downstream components that predicted human intent is sufficiently validated for continued execution of the interaction strategy. Conversely, when the alignment metric falls below the required confidence threshold, the subsystem can generate a belief-update vector that modifies the intent-state tensor to reflect newly observed human behavior. This update can propagate to other subsystems within the system 202, enabling downstream decision components to modify interaction parameters, adjust motion trajectories, or suspend execution of the robot action. By structuring human-intent inference as a collection of belief vectors and response tensors, the intent identifying subsystem 226 can provide a continuous probabilistic representation of human readiness and predicted behavior. In this way, the subsystem can operate as the intent-state tensor generator that governs how system 202 interprets human engagement signals and synchronizes robot interaction strategies with predicted human responses.

The system 202 can include a semantic detection subsystem 228. The semantic detection subsystem 228 can function as the environmental and interaction-state perception component that interprets sensor observations and converts them into structured semantic information usable by other subsystems of the system 202. The semantic detection subsystem 228 can be the structured semantic interpretation authority that defines, at any given moment, the system's contextual understanding of the surrounding environment and the human participant within that environment. Rather than relying solely on raw sensor data streams or simple threshold-based object detection, the subsystem can construct semantic representations of environmental conditions and interaction-relevant features that evolve as new observations are received. The semantic detection subsystem 228 can include a semantic state representation, which may encode detected environmental entities, interaction-relevant objects, and contextual conditions associated with a robotic interaction. Each detected entity may correspond to a semantic feature such as a human limb position, an object being transferred, a nearby obstacle, or an environmental structure that may influence the interaction. These semantic states can be continuously updated using observations provided by sensors associated with robot 216, including cameras, depth sensors, lidar systems, or other environmental sensing devices. The subsystem can interpret sensor observations to derive contextual attributes such as spatial location, motion vectors, object classification, and environmental relationships that may influence robotic behavior. The semantic detection subsystem 228 can maintain structured semantic parameters that may include an object-state descriptor, an interaction-context indicator, and a semantic environment vector describing the surrounding environment relevant to the robot action. The object-state descriptor may represent attributes associated with detected objects or entities, such as object type, position, orientation, or motion trajectory. The interaction-context indicator may represent contextual conditions affecting the interaction, such as whether the interaction zone is clear, whether a human participant is within reach of the robot, or whether environmental movement may interfere with the interaction. The semantic environment vector may encode spatial and relational information describing how objects, humans, and environmental features are positioned relative to the robot and to one another. The semantic detection subsystem 228 can further provide interpreted semantic observations to the intent identifying subsystem 226, enabling that subsystem to update its belief-space representation of human readiness and predicted interaction behavior. For example, semantic detection may identify hand positioning, body orientation, or movement trajectories that may indicate readiness to receive an object. By providing these interpreted semantic signals, the semantic detection subsystem 228 can support higher-level reasoning regarding human intent and interaction feasibility. In addition to detecting interaction-relevant human features, the semantic detection subsystem 228 can also identify environmental conditions that may influence robot actions. For example, the subsystem may detect objects, obstacles, environmental structures, or moving entities within the robot's operating environment. These observations may allow the subsystem to determine whether the interaction space is unobstructed or whether additional environmental considerations must be addressed before performing a robot action. The semantic detection subsystem 228 may employ machine learning models to interpret sensor observations captured by robot 216. For example, perception models may encode visual imagery, depth data, lidar point clouds, or other environmental sensing outputs into semantic feature embeddings representing detected objects, human pose structures, spatial relationships, and environmental context. These encoded semantic features may then be decoded into classifications or structured scene representations identifying entities such as human limbs, obstacles, objects of interest, or interaction regions. In this way, the semantic detection subsystem can convert raw sensor measurements into semantically meaningful representations that can be consumed by other subsystems. By maintaining an evolving semantic representation of the environment and interaction context, the semantic detection subsystem 228 can provide a structured understanding of the environment that supports adaptive robotic behavior. Rather than forwarding raw sensor measurements directly to decision-making components, the subsystem can convert those measurements into semantic observations that represent meaningful environmental and interaction features. In this way, the semantic detection subsystem 228 can function as the semantic perception engine that supplies contextual knowledge used by the intent identifying subsystem 226, the obstacle detecting subsystem 230, and the package transferring subsystem 232.

In an example implementation, the semantic detection subsystem 228 can function as a semantic perception module that generates a structured environment-state tensor representing the detected semantic conditions of the environment and interaction space. The subsystem can operate as a semantic feature encoder that defines, at any given moment, the system's contextual understanding of the environment surrounding the robot 216. Rather than relying solely on discrete object-detection outputs, the subsystem can construct and maintain a continuously updated semantic-state tensor derived from multimodal perception inputs and environmental context vectors.

The semantic detection subsystem 228 can include an environment-state tensor, indexed by a semantic environment vector that encodes detected entities, spatial relationships, and contextual attributes associated with the environment and interaction region. Each element of the tensor may correspond to a semantic feature such as human posture classification, object location coordinates, obstacle positions, environmental structure identifiers, or motion vectors describing detected entities. These values can be updated using observation vectors derived from sensors associated with the robot 216 and processed through semantic interpretation models. The subsystem can map detected object coordinates, depth measurements, classification labels, and motion trajectories into the semantic tensor to update probability distributions associated with environmental states. The semantic detection subsystem 228 can maintain structured semantic-state vectors including an object descriptor vector, an interaction-context vector, and a spatial relationship tensor describing the arrangement of detected entities within the environment. The object descriptor vector may encode attributes associated with detected entities such as type, orientation, and motion characteristics. The interaction-context vector may represent contextual conditions affecting the interaction zone, including occupancy conditions, human proximity, or environmental disturbances. The spatial relationship tensor may encode geometric and relational information describing how objects, humans, and environmental structures are positioned relative to the robot 216.

In some implementations, the subsystem can generate an environment-evolution tensor that estimates how detected environmental states may change as a function of robot motion or external movement. This predictive tensor may represent expected environmental transitions based on observed motion patterns, enabling other subsystems to anticipate potential changes in the interaction space. By constructing this semantic-state tensor and associated predictive structures, the semantic detection subsystem 228 can provide a continuously updated semantic representation that informs interaction decision-making across system 202.

The system 202 can include an obstacle detecting subsystem 230. The obstacle detecting subsystem 230 can function as the environmental risk detection and stability assessment component that identifies obstacles, dynamic hazards, and environmental conditions that may affect execution of a robot action. The obstacle detecting subsystem 230 can be the structured environmental risk inference authority that defines, at any given moment, the system's assessment of whether the environment surrounding the robot 216 supports safe continuation of a robotic interaction. Rather than relying solely on raw proximity measurements or simple collision detection, the subsystem can evaluate environmental conditions within a structured risk representation that evolves as new sensor observations are received. The obstacle detecting subsystem 230 can include an environmental risk representation, which may encode detected obstacles, moving entities, and environmental disturbances associated with a robotic interaction. Each detected entity may correspond to a potential interference condition such as a nearby person, a moving object, a structural obstacle, or a transient environmental condition that may disrupt execution of a robot action. These environmental states can be continuously updated using observations provided by sensors associated with the robot 216, including lidar, depth sensors, cameras, proximity sensors, or other environmental sensing devices. The subsystem can interpret sensor observations to derive contextual attributes such as obstacle location, movement direction, predicted trajectory, and proximity to the robot's interaction zone. The obstacle detecting subsystem 230 can maintain structured environmental parameters that may include an obstacle-state descriptor, an environmental stability indicator, and a hazard proximity vector describing the relationship between detected obstacles and the robot's planned action. The obstacle-state descriptor may represent attributes associated with detected obstacles, including object type, spatial position, and movement velocity. The environmental stability indicator may represent whether the interaction environment remains sufficiently stable for safe execution of a robot action. The hazard proximity vector may encode spatial relationships describing how detected obstacles or moving entities relate to the robot's motion trajectory or interaction region. The obstacle detecting subsystem 230 can further provide environmental hazard information to other subsystems of the system 202, including the intent identifying subsystem 226 and the package transferring subsystem 232. For example, the subsystem may determine whether an unexpected obstacle enters the interaction region while the robot prepares to perform an object transfer. If such a condition is detected, the subsystem may signal that the environment has become unstable or that the planned robot action should be modified or delayed. In this way, the obstacle detecting subsystem 230 can contribute to adaptive decision-making by ensuring that robot actions are evaluated in light of environmental safety conditions. In addition to detecting static obstacles, the obstacle detecting subsystem 230 can identify dynamic environmental conditions that may influence robotic interactions. For example, the subsystem may detect a passerby approaching the interaction area, a moving object crossing the robot's planned trajectory, or a sudden environmental disturbance that may interfere with execution of the robot action. These observations can allow the subsystem to determine whether the environment remains within acceptable stability conditions for the planned interaction. Machine learning models may also be used within the obstacle detecting subsystem 230 to detect and predict environmental hazards that may interfere with execution of a robot action. For instance, models may encode environmental sensor observations into spatial occupancy representations, motion feature vectors, or obstacle descriptors. From these encoded representations, the subsystem may decode predicted obstacle trajectories, collision probabilities, or environmental stability indicators representing whether the robot's planned motion path remains unobstructed. These predictions may allow the system to anticipate potential environmental disturbances before they occur. By maintaining an evolving environmental risk representation, the obstacle detecting subsystem 230 can provide a structured assessment of environmental hazards that may affect robot actions. Rather than forwarding raw sensor measurements directly to decision components, the subsystem can convert those measurements into contextual risk indicators that describe the safety and feasibility of performing a robot action. In this way, the obstacle detecting subsystem 230 can function as the environmental safety evaluation engine that informs adaptive robotic interaction across system 202.

In an example implementation, the obstacle detecting subsystem 230 can function as an environmental hazard analysis module that generates a structured hazard-state tensor representing the detected obstacle conditions within the environment surrounding the robot 216. The subsystem can operate as a hazard-state encoder that defines, at any given moment, the system's assessment of environmental safety conditions affecting the robot's interaction zone. Rather than relying solely on binary collision detection outputs, the subsystem can construct and maintain a continuously updated hazard-state tensor derived from multimodal perception inputs and environmental risk vectors. The obstacle detecting subsystem 230 can include a hazard-state tensor, indexed by an environmental hazard vector that encodes detected obstacle entities, motion patterns, and environmental disturbances associated with the environment and interaction space. Each element of the tensor may correspond to a hazard condition such as obstacle position coordinates, predicted movement trajectory, obstacle classification, or proximity to the robot's planned motion path. These values can be updated using observation vectors derived from sensors associated with the robot 216 and processed through environmental interpretation models. The subsystem can map detected obstacle coordinates, motion vectors, and classification features into the hazard tensor to update probability distributions associated with environmental risk states.

The obstacle detecting subsystem 230 can maintain structured hazard-state vectors including an obstacle descriptor vector, an environmental stability vector, and a hazard proximity tensor describing relationships between detected obstacles and the robot's planned actions. The obstacle descriptor vector may encode attributes associated with detected hazards such as obstacle type, spatial position, and motion characteristics. The environmental stability vector may represent the likelihood that the environment will remain stable during execution of the robot action. The hazard proximity tensor may encode spatial relationships describing how obstacles or moving entities intersect with the robot's motion trajectory or interaction zone.

In some implementations, the subsystem can generate an environmental hazard evolution tensor that estimates how detected obstacles may move or change relative to the robot's planned motion. This predictive tensor may represent expected hazard trajectories based on observed motion patterns, enabling other subsystems to anticipate potential environmental interference before it occurs. By constructing this hazard-state tensor and associated predictive structures, the obstacle detecting subsystem 230 can provide a continuously updated environmental risk representation that informs adaptive decision-making across system 202.

The system 202 can include a package transferring subsystem 232. The package transferring subsystem 232 can function as the interaction execution component that performs the physical robot action associated with an interaction between the robot 216 and a human participant or the surrounding environment. The package transferring subsystem 232 can be the structured action execution authority that determines how the robot physically performs a selected interaction strategy once intent inference, semantic interpretation, and environmental stability assessments indicate that execution conditions are satisfied. Although described in some implementations as transferring a package to a user, the subsystem is not limited to package transfer. Rather, the package transferring subsystem 232 can support execution of any robot interaction action, including object transfer, cooperative manipulation, inspection, gesture-based communication, or other interaction behaviors involving a robot and one or more humans or environmental entities.

The package transferring subsystem 232 can include an interaction execution representation, which may encode parameters describing the robot action to be performed. Each interaction state may correspond to a particular execution condition, such as initiating an interaction, adjusting an interaction trajectory, completing an interaction, or suspending the action due to environmental or human-state changes. These interaction states can be updated using observations and signals provided by the intent identifying subsystem 226, the semantic detection subsystem 228, and the obstacle detecting subsystem 230. The subsystem can interpret these inputs to determine whether execution of a robot action should begin, continue, adapt, or terminate. The package transferring subsystem 232 can maintain structured interaction parameters that may include a trajectory specification, an interaction timing parameter, and an execution adjustment indicator describing how the robot should perform a selected interaction. The trajectory specification may represent the spatial path or orientation through which the robot performs the interaction. The interaction timing parameter may represent when the robot initiates or completes the action relative to observed human or environmental conditions. The execution adjustment indicator may represent whether the robot should alter aspects of the interaction, such as modifying a motion trajectory, changing orientation, or adjusting force characteristics during the action. The package transferring subsystem 232 can further incorporate adaptive execution logic that evaluates alignment between predicted and observed interaction conditions during execution of the robot action. For example, the subsystem may determine whether a predicted human response remains consistent with observed human motion as the robot begins to perform the interaction. If the observed conditions remain aligned with the predicted conditions, the subsystem may continue execution of the action. Conversely, if misalignment is detected, the subsystem may modify or suspend the interaction to prevent unsafe or ineffective behavior.

In addition to executing physical interactions, the package transferring subsystem 232 can communicate interaction outcomes and execution states to other subsystems within the system 202. For example, after completing a robot action, the subsystem may provide feedback signals indicating whether the interaction was successful, partially completed, or interrupted due to environmental changes. These outputs may be used by other subsystems to update belief representations, adjust predictive models, or refine subsequent interaction strategies. By maintaining a structured representation of interaction execution states, the package transferring subsystem 232 can coordinate physical robot behavior with the predictive reasoning and environmental awareness maintained by other subsystems of the system 202. Rather than executing predetermined motions in isolation, the subsystem can perform robot actions that remain responsive to evolving human behavior and environmental conditions.

In an example implementation, the package transferring subsystem 232 can function as an interaction execution module that generates a structured interaction-action tensor representing the robot action being executed. The subsystem can operate as an action-state generator that defines, at any given moment, the execution state of a robot interaction relative to predicted human behavior and environmental conditions. Rather than relying solely on fixed motion commands, the subsystem can construct and maintain a continuously updated interaction-state tensor derived from action parameters, sensor observations, and belief-state inputs. The package transferring subsystem 232 can include an interaction-action tensor, indexed by an interaction execution vector that encodes execution parameters associated with the robot action. Each element of the tensor may correspond to execution features such as motion trajectory vectors, orientation parameters, timing conditions, interaction forces, or communication signals generated during the robot action. These values can be updated using observation vectors derived from sensors associated with the robot 216 and control parameters generated by system 202. The subsystem can map predicted interaction states, environmental conditions, and observed responses into the interaction tensor to update probability distributions associated with execution outcomes. The package transferring subsystem 232 can maintain structured execution-state vectors including a trajectory vector, an interaction-force vector, and an execution-alignment tensor describing the correspondence between predicted interaction outcomes and observed conditions during execution. The trajectory vector may encode spatial movement and orientation parameters for the robot action. The interaction-force vector may represent grip force, contact pressure, or other mechanical characteristics associated with the interaction. The execution-alignment tensor may encode the degree to which predicted human responses or environmental conditions correspond to observed states during partial execution of the robot action. In some implementations, the subsystem can generate an interaction-evolution tensor that estimates how the execution state of the robot action may evolve as the interaction proceeds. This predictive tensor may represent expected execution trajectories and interaction outcomes based on predicted human responses and environmental conditions. By constructing this interaction-action tensor and associated predictive structures, the package transferring subsystem 232 can provide a continuously updated execution representation that enables the robot 216 to perform adaptive interactions across a wide range of human-robot and robot-environment scenarios.

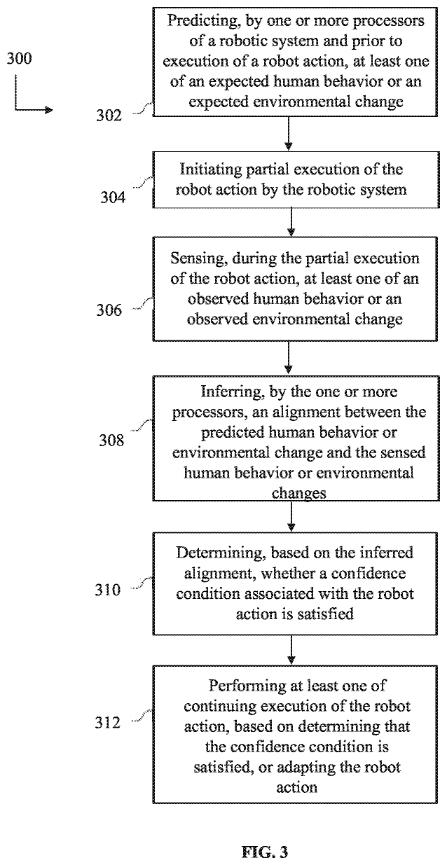

FIG. 3 shows an example method 300 for adaptive robotic interaction. The method 300 can include predicting at least one of an expected human behavior or an expected environmental change associated with a future execution of the robot action, the predicting being performed using a belief-space representation of the human or environment (Step 302). This predicting can generate a predictive interaction model that anticipates how a human participant or the surrounding environment may respond if the robot begins executing a proposed action. Inputs to this prediction can include multimodal sensor observations obtained from the robot, such as camera imagery, depth measurements, lidar data, motion tracking signals, and other environmental sensing outputs. Additional inputs may include semantic observations generated by the semantic detection subsystem, environmental risk indicators produced by the obstacle detecting subsystem, and contextual interaction information maintained by system. These inputs may represent features such as human posture, hand position, orientation toward the robot, object locations, environmental obstacles, and movement patterns within the robot's operating environment. Using these inputs, the intent identifying subsystem may construct a belief-space representation describing possible human states and their associated probabilities. This belief-space representation can encode candidate behavioral states such as readiness to receive an object, uncertainty regarding interaction, approach trajectories, or disengagement behaviors. Predictive models executed by subsystem may then estimate how these states may evolve if a proposed robot action, such as extending an object toward the user, can be initiated.

In some implementations, prediction may involve generating a predicted response vector describing the anticipated motion trajectory or behavioral transition of the human participant. In parallel, the implementations may also predict environmental changes, such as movement of nearby individuals or objects that could affect execution of the robot action. This can be implemented utilizing probabilistic inference algorithms, semantic interpretation models, or belief-space prediction functions. These models may incorporate historical interaction data stored in the database, as well as real-time sensor observations received via communications network. The output can include one or more predicted interaction-state representations, such as predicted human behavior vectors or environmental stability indicators. These predictions can serve as reference expectations against which subsequent sensor observations may be compared during execution of the robot action. Thereby, this prediction can establish the predictive baseline that enables later evaluation of whether the interaction proceeds as expected.

In an example implementation, this prediction can include receiving a multimodal observation vector derived from sensors of the robot, including visual feature embeddings, depth vectors, lidar occupancy grids, motion-trajectory vectors, and contextual environmental attributes. These observations may be encoded by the semantic detection subsystem into a structured environment-state tensor, while contextual hazard indicators may be supplied by the obstacle detecting subsystem. The intent identifying subsystem may map these observation vectors into a belief-state tensor representing a probability distribution over candidate human interaction states. The belief-state tensor may be indexed by a human interaction vector whose elements correspond to latent engagement states such as ready-to-receive, uncertain engagement, approach trajectory, or interaction withdrawal. Using this belief representation and a proposed robot action vector, the subsystem may generate an action-conditioned prediction tensor that models how the human state distribution and environmental state distribution are expected to evolve if the robot initiates the action. This predictive operation may involve probabilistic inference models, latent behavior encoders, or predictive state-transition functions. In some implementations, historical interaction vectors stored in the database may also be used to parameterize the prediction model. The output of this predicting can include a predicted response tensor and associated environmental stability vector representing the expected behavioral and environmental outcomes corresponding to the candidate robot action.

The method 300 can include initiating partial execution of the robot action (Step 304). In this initiation, the system may execute an initial portion of the action in order to observe how the human participant and environment respond. Inputs to this initiation can include the predicted behavior outputs generated by the prior prediction, as well as action parameters selected by system. These parameters may include motion trajectories, object orientations, grip forces, timing parameters, or other execution characteristics associated with the proposed robot action. Execution of this initiation may be coordinated by the package transferring subsystem, which can function as the action execution controller for robot interactions. Although described as transferring a package in some implementations, the subsystem can support any robot interaction behavior, including object handoffs, collaborative manipulation, inspection actions, or gesture-based interactions. The package transferring subsystem may transmit motion commands to the robot, which may include actuators such as robotic arms, manipulators, locomotion mechanisms, or grippers. These actuators may begin executing a portion of the planned motion trajectory, for example, extending an object toward a user or repositioning the robot relative to the user. Partial execution may involve performing only an initial segment of the planned action rather than committing to the full interaction. For example, the robot may begin moving an object toward the user but pause before completing the transfer. This controlled partial execution can allow the system to observe human responses or environmental changes that occur as the robot initiates the interaction. Machinery implementing the initiation may include the motion planner, gait controller, and other control components of robot. These components may generate motor commands and control signals necessary to perform the partial action. The output of this initiation can include both the initial physical movement of the robot and updated sensor observations generated as the robot begins executing the action. These sensor observations may then be used in subsequent steps to determine whether the environment and human participant are responding as predicted.

In an example implementation, this initiation can include initiating partial execution of a robot action by generating and transmitting an initial action-execution tensor to the robot. This tensor may encode a partial trajectory vector, orientation parameters, timing parameters, and interaction-force parameters associated with the candidate action selected by the system. The package transferring subsystem may construct an interaction execution vector representing the initial segment of the planned robot action. Although described as a package transfer in some embodiments, the interaction execution vector may correspond to any robot interaction behavior, including object manipulation, cooperative interaction, inspection actions, or communication gestures. The subsystem may transmit this execution vector to the control stack of robot, including components such as the motion planner, gait controller, and actuator controllers associated with robotic manipulators. These controllers may convert the execution tensor into motor command sequences that initiate movement of the robot. The partial execution stage may intentionally limit the extent of the robot action so that the system can observe environmental responses before committing to the full interaction sequence. For example, the robot may extend an object partially toward a user while maintaining a controllable pause point. The output of this initiation can include an initial robot action state tensor describing the partially executed interaction and an updated sensor observation vector capturing environmental responses triggered by the initial robot motion.

The method 300 can include sensing at least one of an observed human behavior or an observed environmental change using one or more sensors of the robotic system (Step 306). This sensing can allow the system to measure the real-world response of the human participant and the surrounding environment to the robot's initial action. Inputs to this sensing can include sensor data generated during partial execution of the robot action in the initiation. These inputs may include visual data from cameras, depth measurements from structured light or time-of-flight sensors, lidar scans, motion tracking outputs, tactile feedback signals, or other environmental observations captured by sensors integrated within robot. The semantic detection subsystem may process these sensor observations to extract semantic features relevant to the interaction. For example, the subsystem may detect a user's hand position relative to the object being presented by the robot, determine whether the user's body orientation indicates readiness to receive the object, or identify obstacles entering the interaction space. The obstacle detecting subsystem may simultaneously evaluate environmental conditions to determine whether obstacles or environmental disturbances have appeared during execution of the robot action. This subsystem may detect moving objects, nearby individuals, or other hazards that could interfere with safe execution of the interaction. Outputs of this sensing may include structured observation data describing observed human behavior and observed environmental conditions. These observations may be represented as semantic feature vectors, motion trajectories, or environmental state descriptors that capture how the environment has changed during the partial execution of the robot action. Machinery implementing this sensing may include sensor hardware integrated into robot and software modules executing within the system that interpret sensor data and convert it into structured semantic representations. These modules may access computational resources within hardware processors and store intermediate observation results within the memory unit or the database. The outputs of this sensing can provide the actual observed interaction-state data that will be compared against the predicted behavior previously generated.

In an example implementation, sensors integrated within robot may produce a continuous stream of sensor observation vectors containing image embeddings, depth measurements, motion-tracking signals, lidar point clouds, tactile readings, and other environmental signals. These observation vectors may be processed by the semantic detection subsystem, which may transform raw sensor data into a structured semantic feature tensor representing detected human posture vectors, hand trajectories, object locations, and spatial relationships within the interaction region. Simultaneously, the obstacle detecting subsystem may analyze sensor vectors to produce a hazard-state tensor describing obstacles, moving entities, or environmental disturbances that may influence execution of the robot action. The resulting observed response tensor may encode both human behavior vectors and environmental condition vectors representing the current state of the interaction environment. These tensors may be stored in the memory structures within the system and forwarded to inference components responsible for evaluating predicted-to-observed correspondence. The output of this sensing can therefore include a structured observed behavior tensor representing the actual environmental and human responses occurring during partial execution of the robot action.

The method 300 can include inferring an alignment between the predicted human behavior or environmental change and the sensed human behavior or environmental change (Step 308). This inferring can determine whether the real-world response of the human participant or environment corresponds to the predictions generated prior to execution of the robot action. Inputs to this inferring may include the predicted behavior representations generated previously and the observed behavior representations. These inputs may include predicted response vectors, predicted environmental state indicators, observed motion trajectories, semantic interaction features, or environmental stability measurements. The system may compute an alignment metric that measures the degree of correspondence between predicted and observed states. For example, the system may evaluate whether a predicted human hand trajectory aligns with the observed motion of the user's hand, or whether predicted environmental stability corresponds to observed conditions in the interaction zone. In some implementations, the alignment metric may be computed within the intent identifying subsystem, which may update its belief representation using newly observed data. The subsystem may calculate probabilistic similarity measures or confidence scores representing the degree to which the predicted human state matches the observed state. The implementations can utilize probabilistic inference algorithms, belief-space comparison models, or vector similarity calculations to execute this process. These operations may utilize data stored in the memory unit and intermediate semantic observations produced by the semantic detection and obstacle detecting subsystems. In some implementations, machine learning models may also assist with evaluating alignment between predicted and observed interaction states. For example, models may encode predicted human behavior vectors and observed behavior vectors into a shared feature space and decode similarity scores or confidence values representing whether the predicted interaction outcome remains valid. The output of this inferring can include an alignment determination representing whether predicted and observed behaviors correspond within an acceptable tolerance. This determination may be expressed as a confidence score, probability value, or other alignment metric that quantifies the level of correspondence between expected and observed interaction outcomes.

In an example implementation, this inferring can include computing an alignment tensor representing the degree of correspondence between the predicted response tensor and the observed response tensor. The implementations may utilize inference routines within intent identifying subsystem and may evaluate the predicted and observed tensors using similarity metrics or probabilistic comparison functions. For example, the system may compute a belief-alignment metric that measures how closely a predicted human motion trajectory corresponds to an observed trajectory vector or how closely predicted environmental stability corresponds to the observed hazard-state tensor. The alignment operation may produce a correspondence vector containing probability scores or divergence values representing the similarity between predicted and observed states across multiple interaction dimensions. These dimensions may include human posture alignment, hand-trajectory alignment, obstacle proximity, and environmental stability indicators. The output of this inferring can therefore include an alignment metric tensor that quantifies the degree to which the observed interaction state corresponds to the predicted interaction state.

The method can include determining, based on the inferred alignment, whether a confidence condition associated with the robot action is satisfied (Step 310). This determination can evaluate whether the alignment metric computed previously is sufficient to allow continued execution of the robot action. Inputs to this determination may include the alignment metric as well as predefined confidence thresholds stored within the system. These thresholds may represent acceptable levels of correspondence between predicted and observed behavior required for safe execution of the robot action. The system may compare the alignment metric to these thresholds in order to determine whether predicted interaction conditions remain valid. For example, if the predicted human motion trajectory closely matches the observed trajectory, the alignment metric may exceed the required confidence threshold. This evaluation may be performed by the intent identifying subsystem or other decision modules within the system. The system may retrieve threshold parameters stored in the memory unit and compute comparison operations that determine whether the confidence condition has been satisfied. This determination may be implemented with decision logic implemented in software modules of the system. These modules may evaluate confidence conditions associated with human intent predictions, environmental stability predictions, or other interaction constraints. The output this determination can include a confidence determination signal indicating whether the robot action should proceed or whether adaptation may be required.

In an example implementation, this determination can include evaluating the alignment metric tensor against one or more predefined confidence threshold vectors stored within the system. The system may compare elements of the alignment tensor to corresponding elements in the confidence threshold vector to determine whether predicted interaction conditions remain valid. These thresholds may represent acceptable ranges of predicted-to-observed correspondence required for safe execution of the robot action. For example, if the alignment tensor indicates that the predicted human engagement state remains within an acceptable tolerance of the observed state, the system may determine that the confidence condition is satisfied. Conversely, if divergence between predicted and observed states exceeds the threshold, the system may determine that the confidence condition is not satisfied. The output of this determination can include a confidence evaluation vector indicating whether each evaluated interaction dimension satisfies its corresponding confidence threshold.

The method 300 can include performing at least one of (i) continuing execution of the robot action, based on determining that the confidence condition is satisfied, or (ii) adapting the robot action by modifying at least one of a motion trajectory, timing, force, orientation, communication, or execution sequence of the robot action based on determining that the confidence condition is not satisfied (Step 312). Inputs to this performing may include the confidence determination signal, updated sensor observations from robot, and interaction parameters associated with the robot action. These inputs may be evaluated by the package transferring subsystem, which may determine how the robot should proceed. If the confidence condition is satisfied, the subsystem may permit continued execution of the robot action. For example, the robot may complete an object transfer by releasing the object to the user or continuing a planned interaction trajectory. If the confidence condition is not satisfied, the subsystem may adapt the robot action. Adaptation may include modifying the robot's motion trajectory, adjusting the timing of the interaction, repositioning the object, altering grip forces, or temporarily suspending the action until environmental conditions stabilize. Machinery implementing this performing may include robot control components such as the motion planner, gait controller, and other execution modules associated with the robot. These components may generate control signals that alter the robot's motion or interaction behavior. The output of this performing can include a completed or modified robot action, along with updated interaction state information that may be stored within database or used by other subsystems to refine predictive models. Through this performing, the method can implement an adaptive interaction loop in which robot behavior dynamically adjusts based on real-time alignment between predicted and observed conditions.

In an example implementation, if the confidence evaluation vector indicates that required confidence conditions are satisfied, the package transferring subsystem may generate a continuation execution tensor that extends the robot action trajectory toward completion. This tensor may include updated motion vectors, orientation parameters, interaction timing parameters, and interaction-force parameters. If the confidence condition is not satisfied, the subsystem may instead generate an adaptive execution tensor that modifies the robot action. Adaptation may include altering trajectory vectors, adjusting orientation parameters, modifying timing vectors, or temporarily suspending the robot action. These execution tensors may be transmitted to the control systems of the robot, where actuator controllers convert the execution tensors into motor commands governing robot motion. The output this performing can include an updated robot interaction state tensor representing either the continued execution or the adaptive modification of the robot action, thereby completing a predictive interaction control loop in which robot behavior dynamically responds to alignment between predicted and observed environmental conditions.

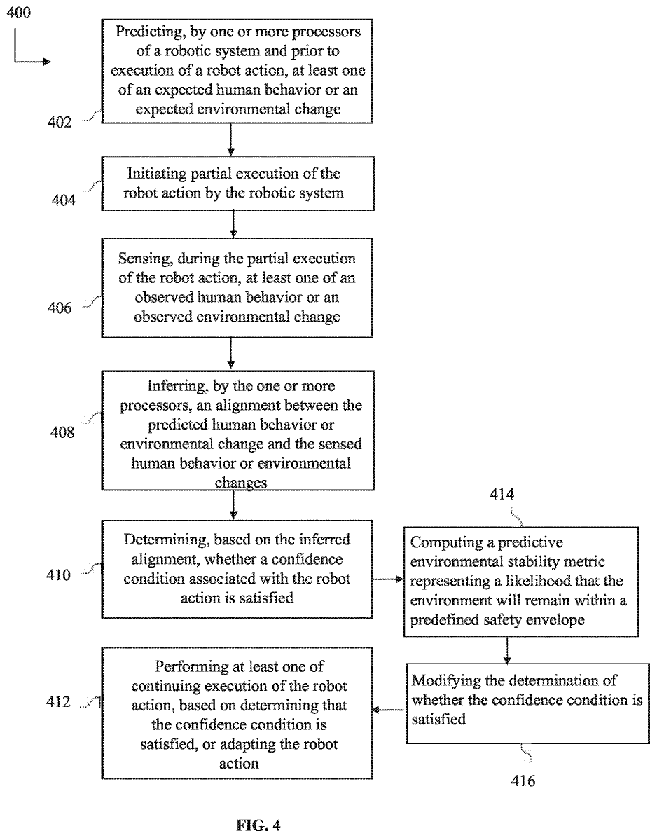

FIG. 4 is an example method 400 of adaptive robot interaction that further includes a prediction of environmental stability. Steps 402, 404, 406, 408, 410, and 412 can be similar to those in FIG. 3, and for the sake of brevity, are not further described here. The method 400 can include computing a predictive environmental stability metric representing a likelihood that the environment will remain within a predefined safety envelope during continued execution of the robot action (Step 414). This computation can provide that the robotic system will remain within a predefined safety envelope during continued execution of the robot action. While other steps can evaluate correspondence between predicted and observed human behavior, this computation can introduce an additional layer of reasoning directed to environmental dynamics that may influence safe completion of the interaction. Inputs to this computation can include environmental observations obtained during partial execution of the robot action. These observations may be derived from sensors associated with the robot, including vision sensors, lidar systems, depth sensors, proximity sensors, or other environmental sensing devices. The observations may be processed by the semantic detection subsystem to identify objects, spatial structures, and interaction-relevant entities within the environment. The obstacle detecting subsystem may further analyze these observations to determine whether obstacles, moving entities, or other environmental disturbances are present within or near the robot's planned motion path. Using these inputs, system may generate an environmental stability assessment describing how likely the environment is to remain suitable for safe continuation of the robot action. This assessment may involve evaluating factors such as the proximity of detected obstacles, predicted movement of nearby entities, spatial clearance within the interaction region, and the relationship between the robot's planned motion trajectory and surrounding environmental features. For example, if sensor observations indicate that a nearby individual is moving toward the interaction region, the system may determine that environmental stability is decreasing. This computation can be executed environmental prediction or risk-evaluation models. These models may analyze the current environmental state and generate a stability metric describing the probability that the environment will remain within acceptable safety conditions during the remainder of the robot action. The output of this computation can include an environmental stability indicator, which may represent a probability, score, or other quantitative measure describing the predicted stability of the environment. This indicator can be used to refine the confidence determination associated with the robot action.

In an example implementation, this computation can include computing a predictive environmental stability tensor representing the likelihood that the environment surrounding the robot will remain within a predefined safety envelope during continued execution of a robot action. This computation may generate a predictive assessment of environmental dynamics that complements the predicted human-response tensor evaluated earlier in the method. Inputs to this computation may include an environment-state tensor generated by the semantic detection subsystem, a hazard-state tensor generated by the obstacle detecting subsystem, and one or more robot action vectors representing the currently executing interaction trajectory. These tensors may encode semantic features such as detected obstacle coordinates, motion trajectories of nearby entities, environmental occupancy distributions, and spatial relationships between robot motion paths and surrounding objects. The implementations may apply predictive environmental modeling functions to these tensors to estimate how the environment may evolve over a future temporal horizon. For example, the system may generate a hazard-evolution tensor describing predicted movement trajectories of detected obstacles or environmental actors relative to the robot's interaction region. This predictive tensor may be derived using motion extrapolation models, probabilistic occupancy mapping, or learned environment-dynamics models. Using the hazard-evolution tensor and the current robot action vector, the system may compute an environmental stability metric tensor that quantifies the probability that the interaction environment will remain within a predefined safety envelope during continued execution of the robot action. The safety envelope may represent spatial boundaries, motion thresholds, or environmental conditions under which safe robot interaction can occur. In some implementations, the stability metric tensor may include components such as a hazard proximity vector, a trajectory-intersection probability vector, and an environmental disturbance likelihood vector. These vectors may collectively describe the likelihood that obstacles will intersect the robot's planned trajectory, that environmental actors will enter the interaction zone, or that environmental motion will disrupt the interaction. The output of this computation can therefore include a structured environmental stability tensor representing the predicted stability of the environment relative to the robot's ongoing action. This tensor may be transmitted to downstream decision components of the system, where it may influence whether the robot action should proceed or be modified.

The method 400 can include modifying the determination of whether the confidence condition is satisfied based on the predictive environmental stability metric, such that continued execution of the robot action is permitted only when both the inferred alignment and the predictive environmental stability metric satisfy respective thresholds (Step 416). This determination can provide that environmental risk predictions can influence the decision of whether the robot action should continue or be adapted. Inputs to this determination can include the alignment determination, the confidence evaluation, and the environmental stability indicator. These inputs can provide both interaction-level information (such as correspondence between predicted and observed human behavior) and environmental-level information describing the stability of the interaction environment. The implementations may evaluate these inputs to determine whether the robot action remains safe and appropriate to continue. For example, even if predicted and observed human behaviors remain aligned, the system may determine that the robot action should not continue if the environmental stability indicator suggests that an obstacle may soon enter the interaction region or that environmental conditions may change in a way that could compromise safety. In some implementations, the environmental stability indicator may adjust or refine the confidence determination generated earlier in the method. For instance, the system may reduce the confidence level associated with continuing the robot action when predicted environmental stability falls below a specified threshold. Conversely, when environmental stability remains high, the confidence determination may remain unchanged or may be strengthened. This determination may be implemented utilizing the alignment determination and environmental stability assessment to produce a final interaction decision. The output of this determination can include a modified confidence determination that reflects both predicted human-response alignment and predicted environmental stability. This modified determination may then guide subsequent execution behavior, such as continuing the robot action or adapting the robot action.

In an example implementation, this determination can include modifying the confidence-condition evaluation tensor associated with the robot action based on the predictive environmental stability tensor. This can integrate environmental risk predictions into the decision process governing continuation or adaptation of the robot action. Inputs to this determination may include the alignment tensor representing correspondence between predicted and observed human behavior, the confidence evaluation vector generated from that alignment and the environmental stability tensor. These inputs may collectively represent both interaction-level confidence and environment-level safety conditions. The implementations may combine these inputs by applying a confidence modulation function that integrates the environmental stability tensor with the alignment tensor. For example, the system may compute a confidence-modulation vector in which elements of the environmental stability tensor scale or weight the alignment-based confidence scores. If environmental stability is predicted to remain high, the confidence scores associated with continuing the robot action may remain unchanged or may be strengthened. Conversely, if environmental stability is predicted to degrade, such as when a moving obstacle is predicted to enter the interaction zone, the confidence scores associated with continued execution may be reduced. In some implementations, the system may compute a composite decision tensor representing the combined evaluation of human-intent alignment and environmental stability. This tensor may be compared against predefined safety thresholds to determine whether the robot action should proceed. If the composite decision tensor indicates that both interaction alignment and environmental stability conditions are satisfied, the system may permit continuation of the robot action. If the tensor indicates that environmental stability falls below acceptable thresholds, the system may modify the execution decision tensor used by the package transferring subsystem. Such modifications may include generating an adaptive action tensor that pauses the robot action, alters its trajectory, delays execution timing, or transitions to an alternate interaction strategy. The output of this determination can therefore include a modified confidence-condition tensor that incorporates both predicted human-response alignment and environmental stability predictions. This tensor may serve as the final decision input governing whether the robot continues executing the current action or transitions to an adaptive interaction behavior.

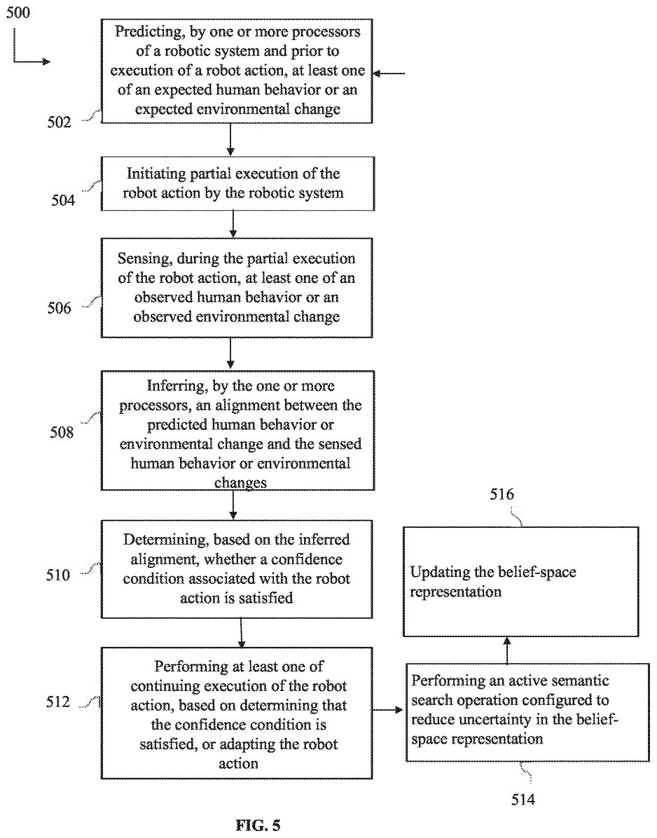

FIG. 5 is an example method 500 of adaptive robot interaction that further includes an active semantic search and belief-space update process. Steps 502, 504, 506, 508, 510, and 512 can be similar to those in FIG. 3, and for the sake of brevity, are not further described here. The method 500 can include performing an active semantic search operation configured to reduce uncertainty in the belief-space representation (Step 514). This operation can allow the robotic system to gather additional information when the current belief representation contains uncertainty regarding the state of the environment or the intentions of a human participant. While earlier steps evaluate correspondence between predicted and observed behaviors, this operation can introduce a targeted sensing process directed to acquiring additional semantic observations that improve the reliability of the system's internal state representation. Inputs to this operation can include the current belief-space representation, which may encode probabilistic estimates of environmental conditions, human intent states, and other interaction-relevant variables. These estimates may be derived from sensor observations obtained during partial execution of the robot action and interpreted by the semantic detection subsystem and the obstacle detecting subsystem. When the system determines that the belief representation contains uncertainty exceeding a defined threshold, the system may initiate an active search procedure designed to reduce that uncertainty. This operation may involve directing sensors of the robot toward specific regions of the environment or toward particular objects or individuals relevant to the interaction. For example, the system may adjust camera orientation, reposition the robot slightly, illuminate the interaction area, or perform additional scanning with lidar or depth sensors. The goal of this operation can be to collect additional observations that clarify ambiguous environmental or behavioral conditions. This operation can be implemented using perception and decision modules of the robotic system. These modules may evaluate which sensing actions are likely to provide the most informative observations relative to the uncertain portions of the belief representation. The output of this operation can include additional sensor observations that provide new semantic information about the environment or the human participant involved in the interaction.

In an example implementation, this operation can include generating an active semantic search tensor representing sensor actions selected to reduce uncertainty within the belief-space representation. Inputs to this computation may include a belief-state tensor representing the current probabilistic estimate of environmental and human interaction states, along with uncertainty vectors identifying portions of the belief state that remain ambiguous. The system may compute an information-gain vector that estimates how candidate sensing actions will reduce uncertainty within the belief tensor. Based on this evaluation, the system may generate a search-action tensor specifying sensing behaviors such as camera orientation changes, sensor scanning trajectories, or robot repositioning vectors. Execution of these sensing actions may generate new observation tensors representing additional semantic features detected within the environment. These tensors can be provided to downstream processes responsible for updating the belief representation.

The method 500 can further include updating the belief-space representation (Step 516) based on the additional observations obtained during the active semantic search. This update can refine the system's internal understanding of the environment and the human participant involved in the interaction. Inputs to this update can include the prior belief representation as well as the new sensor observations obtained during the active semantic search operation. These observations may include newly detected object positions, updated human posture information, environmental motion measurements, or other semantic features identified by the perception subsystems of the robot. The implementations may incorporate these observations into the belief representation by adjusting probability values associated with the candidate states represented within the belief model. For example, if additional sensor observations confirm that a user's hand is positioned to receive an object, the system may increase the probability associated with a “ready-to-receive” state. Conversely, if observations indicate that an obstacle has entered the interaction region, the system may adjust environmental state probabilities accordingly. This update can be executed by probabilistic inference or belief-update models implemented by the robotic system. The resulting updated belief representation may then be used to guide subsequent decisions regarding continuation or adaptation of the robot action.

In an example implementation, this update can include updating a belief-state tensor based on the observation tensors generated during the active semantic search operation. The system may combine the prior belief-state tensor with the new observation tensors using a belief-update function that recalculates probability distributions associated with candidate interaction states. The update may generate a revised belief tensor representing an improved estimate of the current environmental and interaction conditions. This updated belief tensor can then be supplied to earlier stages of the interaction reasoning process, such as the prediction step, allowing the implementations to recompute predicted behaviors and repeat the interaction evaluation loop if necessary.

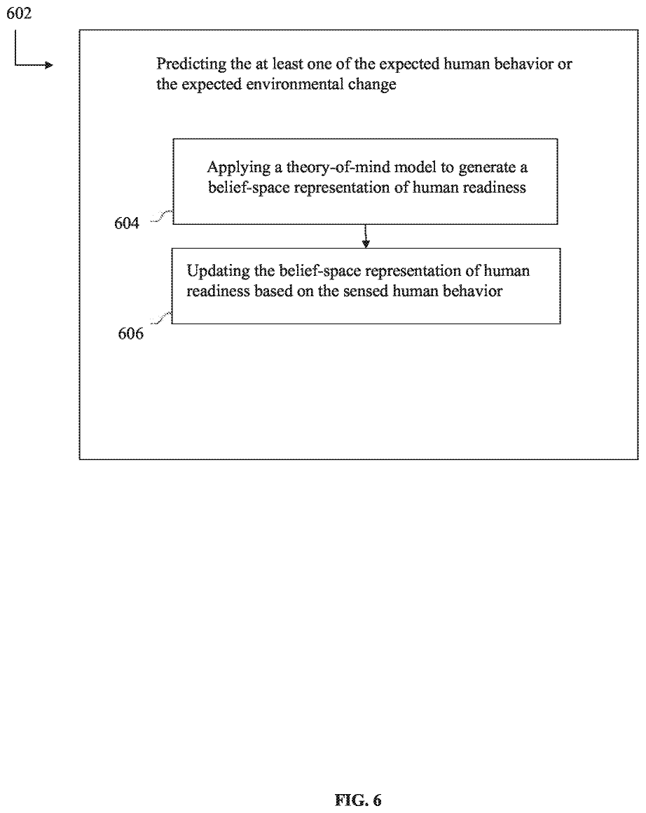

FIG. 6 illustrates substeps that may be performed as part of the predicting step of the methods of FIGS. 3-5 and 7. Step 602 can correspond to predicting at least one of an expected human behavior or an expected environmental change prior to execution of a robot action, which may be similar to the prediction operation described in connection with step 302 of FIG. 3. The predicting 602 can include operations that incorporate a theory-of-mind reasoning process to model the readiness or expected response of a human participant. These operations may refine the prediction of human behavior by explicitly modeling human mental states, intentions, or interaction readiness.

The predicting 602 can include applying a theory-of-mind model to generate a belief-space representation of human readiness (Step 604). This application can allow the robotic system to estimate how a human participant may interpret or respond to a robot action. While other steps may rely primarily on direct sensor observations of the environment or the human participant, this operation can introduce a reasoning layer that predicts human mental states or intentions based on observed behavior and contextual information. Inputs to this application can include sensor observations obtained from the robot, such as visual data, depth measurements, lidar observations, or motion-tracking signals representing the posture, position, and movement of the human participant. These observations may be processed by perception modules, such as the semantic detection subsystem, to identify interaction-relevant features including hand position, body orientation, gaze direction, and proximity to the robot. Contextual interaction information, such as the object being transferred or the spatial relationship between the robot and the human participant, may also be provided as input. Using these inputs, the implementations may apply a theory-of-mind model to estimate the readiness or likely response of the human participant to a proposed robot action. For example, the system may determine whether the human appears prepared to receive an object, whether the human is approaching or withdrawing from the interaction region, or whether the human's posture indicates attention toward the robot. This applying may be implemented using probabilistic reasoning models or predictive models executed by the implementations. The output of this operation can include a belief-space representation describing the estimated readiness of the human participant and possible behavioral responses to the robot action.

In an example implementation, this operation can include generating a human-readiness belief tensor representing probabilistic estimates of candidate interaction states associated with the human participant. Inputs to this computation may include observation tensors derived from sensor data, such as posture vectors, hand-position coordinates, motion-trajectory vectors, and orientation features. The implementations may encode these observation tensors into a belief-state tensor whose elements represent candidate readiness states such as ready-to-receive, uncertain engagement, approach trajectory, or interaction withdrawal. The resulting belief tensor can represent a structured estimate of human readiness that may be used to predict expected human behavior during the interaction.

The predicting 602 can further include updating the belief-space representation of human readiness based on the sensed human behavior (Step 606). This update can allow the system to refine the belief representation as new sensor observations are obtained during execution of the robot action. Inputs to this update can include the previously generated belief-space representation as well as sensor observations representing the current behavior of the human participant. These observations may include updated posture information, hand-movement trajectories, orientation changes, or other behavioral signals detected by the robot's sensing systems. The implementations may incorporate these observations into the belief representation by adjusting probability values associated with candidate readiness states. For example, if updated sensor observations indicate that the human participant is extending a hand toward the robot, the system may increase the probability associated with a ready-to-receive state. Conversely, if the human moves away from the interaction region, the system may increase the probability associated with a disengagement state. This update may be performed by probabilistic belief-update models executed by the implementations. The resulting updated belief representation may then be used to refine predictions regarding human behavior and guide subsequent interaction decisions.

In an example implementation, this update can include updating a human-readiness belief tensor based on generated observation tensors representing sensed human behavior. The implementations may combine the prior belief tensor with the observation tensors using a belief-update function that recalculates probability distributions associated with candidate readiness states. This may generate an updated belief tensor representing an improved estimate of the human participant's current interaction readiness. The updated belief tensor may then be supplied downstream, enabling the robotic system to refine its prediction of expected human behavior prior to or during execution of the robot action.

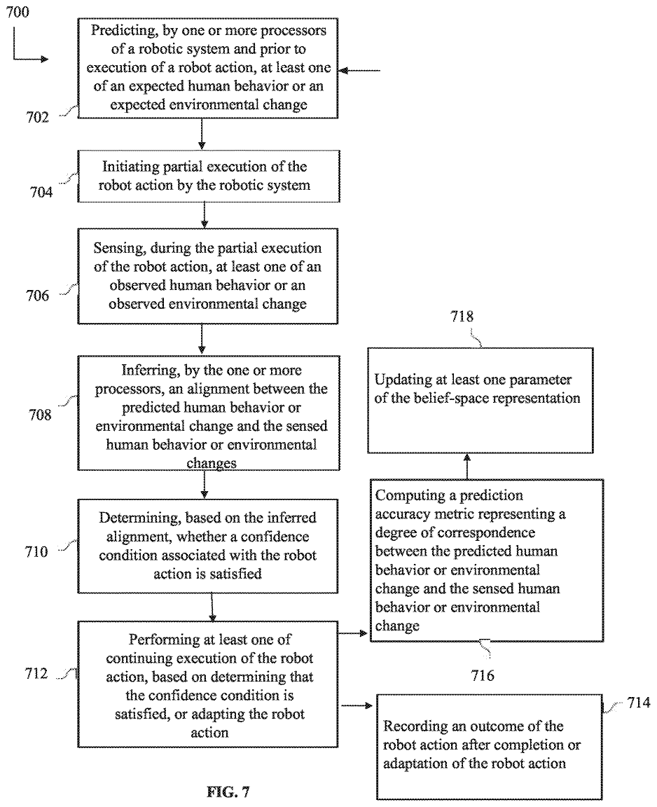

FIG. 7. is an example method 700 of adaptive robot interaction as in FIGS. 3-5 that further includes an interaction outcome recording and prediction-accuracy learning process. Steps 702, 704, 706, 708, 710, and 712 can be similar to those in FIG. 3, and for the sake of brevity, are not further described here. The method 700 can include recording an outcome of the robot action after completion or adaptation of the robot action (Step 714). This can allow the robotic system to maintain a record of interaction outcomes that may be used for subsequent evaluation, diagnostics, or learning processes. While earlier steps evaluate correspondence between predicted and observed interaction states during execution of the robot action, this operation can capture the final state of the interaction once the robot action has either completed successfully or been modified or terminated due to environmental or behavioral conditions. Inputs to this recording can include execution-state information generated during performance of the robot action, such as the final position of the robot, interaction timing data, object-transfer completion indicators, and environmental or human-state observations detected during the interaction. These inputs may be generated by sensors associated with the robot and interpreted by subsystems such as the semantic detection subsystem and the obstacle detecting subsystem. The system may also receive signals from robot control components indicating whether the robot action completed successfully, was interrupted, or was adapted during execution. This recording may involve storing interaction outcome data within system memory or a database associated with the robotic system. For example, the system may record whether a user successfully received an object, whether the robot modified its trajectory during the interaction, or whether environmental disturbances caused the robot to pause or abort the action. A goal of this operation can be to create a structured record describing the final interaction state and the sequence of events that occurred during the robot action. This operation can be implemented using logging, monitoring, or data-recording modules executed by the implementations. The output of this operation can include a stored interaction outcome record that may later be used for evaluating prediction performance or updating internal predictive models.

In an example implementation, this recording can include generating an interaction-outcome tensor representing the final execution state of the robot action. Inputs to this computation may include an execution-state tensor describing robot motion and interaction parameters, along with observation tensors representing human behavior and environmental conditions detected during the interaction. The implementations may encode these inputs into a structured outcome tensor that captures attributes such as completion status, execution duration, trajectory modifications, and observed interaction responses. This tensor may be stored in association with the predicted interaction tensors generated earlier in the method, enabling downstream processes to evaluate prediction accuracy and update belief representations.

The method 700 can further include computing a prediction accuracy metric representing a degree of correspondence between predicted human behavior or environmental change and the sensed human behavior or environmental change (Step 716). This computation can evaluate how accurately the predictive models used in earlier stages of the method estimated the actual interaction outcomes. Inputs to this computation can include predicted behavior representations generated previously and observed behavior representations generated during sensing operations performed during the robot action. These representations may include predicted human motion trajectories, predicted environmental stability indicators, observed human posture data, and environmental state observations obtained during execution of the robot action. The implementations may evaluate these inputs to determine how closely the predicted interaction conditions matched the observed conditions. For example, the implementations may determine whether the predicted motion of a human hand corresponded to the actual trajectory observed during the interaction, or whether predicted environmental conditions accurately reflected the presence or absence of obstacles. This computation may be implemented using comparison or evaluation models executed by the implementations. These models may analyze differences between predicted and observed states to generate a prediction accuracy metric that quantifies how well the system's predictions corresponded to actual outcomes. The output of this computation can include a prediction accuracy indicator representing the reliability of the predictive models used during the interaction.

In an example implementation, this computation can include generating a prediction-accuracy tensor representing the degree of correspondence between predicted interaction tensors and observed interaction tensors. The system may compute difference vectors, similarity scores, or probabilistic divergence metrics between predicted human-behavior tensors and observed behavior tensors. These values may be aggregated into a prediction-accuracy tensor that summarizes prediction performance across multiple interaction dimensions, such as human motion prediction, environmental stability prediction, and interaction timing. This tensor may be provided to downstream processes responsible for updating predictive model parameters or belief representations.

The method 700 can further include updating at least one parameter of the belief-space representation (Step 718) based on the prediction accuracy metric. This update can allow the robotic system to refine its predictive models and improve future interaction predictions. Inputs to this update can include the prior belief-space representation maintained by the system as well as the prediction accuracy metric generated previously. These inputs may provide information describing how well the system's prior predictions matched observed interaction outcomes. When prediction accuracy is low, the implementation may adjust belief parameters to better reflect the observed interaction conditions. Conversely, when prediction accuracy is high, the implementation may reinforce existing belief parameters. This update may involve adjusting probability distributions associated with candidate human interaction states, environmental state estimates, or action-response relationships maintained within the belief representation. The update can therefore refine the system's internal model of how humans and environments respond to robot actions. This can be implemented using belief-update or learning algorithms executed by the implementations. These algorithms may update stored model parameters or probabilistic state estimates used by the system's predictive components.

In an example implementation, this update can include updating one or more parameters of a belief-state tensor based on the prediction-accuracy tensor. The implementations may compute parameter-adjustment vectors that modify probability weights or transition parameters associated with candidate interaction states represented in the belief tensor. These updates may produce a revised belief tensor representing an improved estimate of how human behavior and environmental conditions evolve during robot interactions. The updated belief tensor may then be supplied to the prediction step of the method, allowing the robotic system to generate more accurate predictions in subsequent interaction cycles.

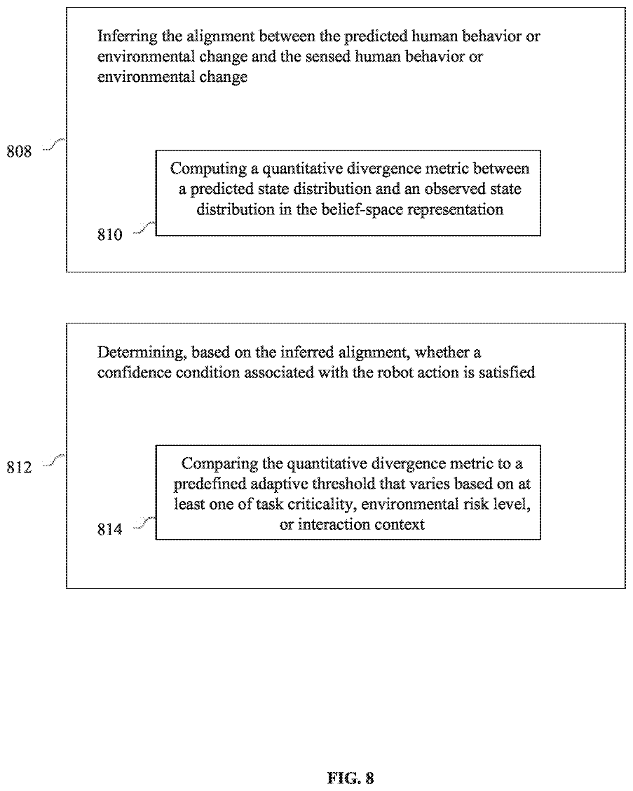

FIG. 8 illustrates substeps that may be performed as part of the inferring and determining steps of the methods of FIGS. 3-5 and 7. Step 808 can correspond to inferring the alignment between the predicted human behavior or environmental change and the sensed human behavior or environmental change, which may be similar to the inference operation described in connection with step 308 of FIG. 3. The inferring 808 can include operations that evaluate the degree of correspondence between predicted and observed interaction states represented within a belief-space representation. The inferring 808 can include computing a quantitative divergence metric between a predicted state distribution and an observed state distribution in the belief-space representation (Step 810). This computation can allow the robotic system to measure how closely predicted interaction outcomes correspond to actual observed outcomes during execution of the robot action. This can introduce a quantitative comparison that characterizes differences between predicted and observed interaction states within the belief representation. Inputs to this computation can include a predicted state distribution representing the expected human behavior or environmental condition and an observed state distribution representing the actual sensed behavior or environmental condition. These distributions may be derived from belief-space representations maintained by the robotic system, which encode probabilistic estimates of candidate interaction states. The predicted state distribution may be generated during prediction, while the observed state distribution may be derived from sensor observations obtained during partial execution of the robot action. These sensor observations may include visual measurements, depth data, lidar observations, or motion-tracking signals interpreted by perception components of the robotic system. Using these inputs, the implementations may compute a divergence metric that quantifies the difference between the predicted and observed distributions. For example, the system may evaluate the difference between predicted and observed probability values associated with candidate interaction states or environmental conditions. This computation may involve applying statistical distance measures or other similarity metrics that measure divergence between probability distributions. This computing may be implemented using probabilistic comparison models or evaluation algorithms executed by the implementations. The output of this operation can include a quantitative divergence metric representing the degree of correspondence between predicted and observed interaction states.

In an example implementation, this operation can include computing a divergence tensor representing the difference between a predicted belief-state tensor and an observed belief-state tensor. Inputs to this computation may include a predicted interaction tensor representing expected human behavior or environmental change and an observation tensor representing sensed behavior or environmental conditions. The implementations may compute element-wise differences, similarity scores, or probabilistic divergence values across the tensors to generate a divergence tensor that captures variation between predicted and observed state distributions. This divergence tensor can represent the degree of alignment between predicted and observed interaction states and may be supplied downstream for use in evaluating whether a confidence condition associated with the robot action is satisfied.

Step 812 can correspond to determining, based on the inferred alignment, whether a confidence condition associated with the robot action is satisfied, which may be similar to the determination operation described in connection with step 312 of FIG. 3. The determining 812 can include operations that evaluate whether the divergence between predicted and observed interaction states remains within acceptable limits for continuing execution of the robot action. The determining 812 can include comparing the quantitative divergence metric to a predefined adaptive threshold that varies based on at least one of task criticality, environmental risk level, or interaction context (Step 814). This comparison can allow the robotic system to evaluate whether the difference between predicted and observed interaction states is acceptable under current operating conditions. While a fixed threshold may be sufficient in some systems, this operation can introduce an adaptive threshold that accounts for contextual factors associated with the interaction. Inputs to this comparison can include the quantitative divergence metric generated previously and one or more threshold parameters maintained by the robotic system. These threshold parameters may vary based on contextual conditions such as the importance or criticality of the task being performed, the level of environmental risk associated with the interaction environment, or the specific context of the interaction between the robot and a human participant. Using these inputs, the implementations may determine whether the divergence metric falls within an acceptable range. For example, when the divergence metric is below the adaptive threshold, the system may determine that the predicted and observed interaction states remain sufficiently aligned. Conversely, when the divergence metric exceeds the threshold, the system may determine that the alignment condition has not been satisfied and that the robot action should be adapted or modified. This comparison may be implemented using decision logic executed by the implementations. The output of this operation can include a determination indicating whether the confidence condition associated with the robot action is satisfied.

In an example implementation, this operation can include comparing elements of the divergence tensor to elements of an adaptive threshold vector whose values vary based on task-criticality parameters, environmental risk indicators, or interaction-context variables. The implementations may generate a confidence evaluation tensor indicating whether divergence values for each interaction dimension fall within acceptable bounds. This tensor may represent whether predicted and observed interaction states remain sufficiently aligned to permit continued execution of the robot action. The resulting confidence evaluation tensor may then be supplied downstream to control processes responsible for continuing or adapting execution of the robot action.

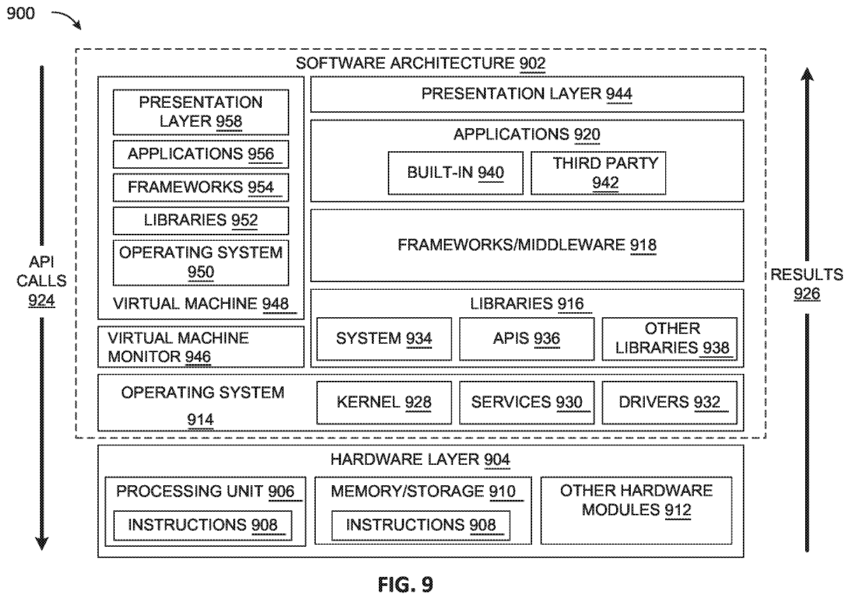

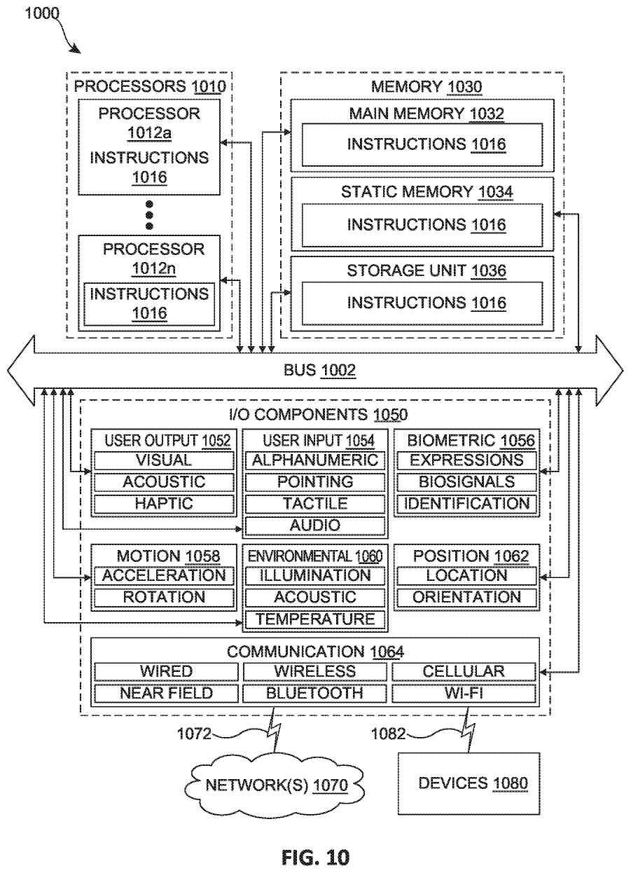

FIG. 9 is a block diagram 900 illustrating an example software architecture 902, various portions of which may be used in conjunction with various hardware architectures herein described, which may implement any of the above-described features. FIG. 9 is a non-limiting example of a software architecture, and it will be appreciated that many other architectures may be implemented to facilitate the functionality described herein. The software architecture 902 may execute on hardware such as a machine 1000 of FIG. 10 that includes, among other things, processors 1010, memory/storage, and input/output (I/O) components 1050. A representative hardware layer 904 is illustrated and can represent, for example, the machine 1000 of FIG. 10. The representative hardware layer 904 includes a processing unit 906 and associated executable instructions 908. The executable instructions 908 represent executable instructions of the software architecture 902, including implementation of the methods, modules and so forth described herein. The hardware layer 904 also includes a memory/storage 910, which also includes the executable instructions 908 and accompanying data. The hardware layer 904 may also include other hardware modules 912. Instructions 908 held by processing unit 906 may be portions of instructions 908 held by the memory/storage 910.

The example software architecture 902 may be conceptualized as layers, each providing various functionality. For example, the software architecture 902 may include layers and components such as an operating system (OS) 914, libraries 916, frameworks/middleware 918, applications 920, and a presentation layer 944. Operationally, the applications 920 and/or other components within the layers may invoke API calls 924 to other layers and receive corresponding results 926. The layers illustrated are representative in nature and other software architectures may include additional or different layers. For example, some mobile or special purpose operating systems may not provide the frameworks/middleware 918.

The OS 914 may manage hardware resources and provide common services. The OS 914 may include, for example, a kernel 928, services 930, and drivers 932. The kernel 928 may act as an abstraction layer between the hardware layer 904 and other software layers. For example, the kernel 928 may be responsible for memory management, processor management (for example, scheduling), component management, networking, security settings, and so on. The services 930 may provide other common services for the other software layers. The drivers 932 may be responsible for controlling or interfacing with the underlying hardware layer 904. For instance, the drivers 932 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 916 may provide a common infrastructure that may be used by the applications 920 and/or other components and/or layers. The libraries 916 typically provide functionality for use by other software modules to perform tasks, rather than interacting directly with the OS 914. The libraries 916 may include system libraries 934 (for example, C standard library) that may provide functions such as memory allocation, string manipulation, file operations. In addition, the libraries 916 may include API libraries 936 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 916 may also include a wide variety of other libraries 938 to provide many functions for applications 920 and other software modules.

The frameworks/middleware 918 provide a higher-level common infrastructure that may be used by the applications 920 and/or other software modules. For example, the frameworks/middleware 918 may provide various graphic user interface (GUI) functions, high-level resource management, or high-level location services. The frameworks/middleware 918 may provide a broad spectrum of other APIs for applications 920 and/or other software modules.

The applications 920 include built-in applications 940 and/or third-party applications 942. Examples of built-in applications 940 may include, but are not limited to, a contacts application, a browser application, a location application, a media application, a messaging application, and/or a game application. Third-party applications 942 may include any applications developed by an entity other than the vendor of the particular platform. The applications 920 may use functions available via OS 914, libraries 916, frameworks/middleware 918, and presentation layer 944 to create user interfaces to interact with users.

Some software architectures use virtual machines, as illustrated by a virtual machine 948. The virtual machine 948 provides an execution environment where applications/modules can execute as if they were executing on a hardware machine (such as the machine 1000 of FIG. 10, for example). The virtual machine 948 may be hosted by a host OS (for example, OS 914) or hypervisor, and may have a virtual machine monitor 946 which manages operation of the virtual machine 948 and interoperation with the host operating system. A software architecture, which may be different from software architecture 902 outside of the virtual machine, executes within the virtual machine 948 such as an OS 950, libraries 952, frameworks 954, applications 956, and/or a presentation layer 958.

FIG. 10 is a block diagram illustrating components of an example machine 1000 configured to read instructions from a machine-readable medium (for example, a machine-readable storage medium) and perform any of the features described herein. The example machine 1000 is in a form of a computer system, within which instructions 1016 (for example, in the form of software components) for causing the machine 1000 to perform any of the features described herein may be executed. As such, the instructions 1016 may be used to implement modules or components described herein. The instructions 1016 cause unprogrammed and/or unconfigured machine 1000 to operate as a particular machine configured to carry out the described features. The machine 1000 may be configured to operate as a standalone device or may be coupled (for example, networked) to other machines. In a networked deployment, the machine 1000 may operate in the capacity of a server machine or a client machine in a server-client network environment, or as a node in a peer-to-peer or distributed network environment. Machine 1000 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 1000 is illustrated, the term “machine” includes a collection of machines that individually or jointly execute the instructions 1016.

The machine 1000 may include processors 1010, memory/storage 1030, and I/O components 1050, which may be communicatively coupled via, for example, a bus 1002. The bus 1002 may include multiple buses coupling various elements of machine 1000 via various bus technologies and protocols. In an example, the processors 1010 (including, for example, a central processing unit (CPU), a graphics processing unit (GPU), a digital signal processor (DSP), an ASIC, or a suitable combination thereof) may include one or more processors 1012a to 1012n that may execute the instructions 1016 and process data. In some examples, one or more processors 1010 may execute instructions provided or identified by one or more other processors 1010. The term “processor” includes a multicore processor including cores that may execute instructions contemporaneously. Although FIG. 10 shows multiple processors, the machine 1000 may include a single processor with a single core, a single processor with multiple cores (for example, a multicore processor), multiple processors each with a single core, multiple processors each with multiple cores, or any combination thereof. In some examples, the machine 1000 may include multiple processors distributed among multiple machines.

The memory/storage 1030 may include a main memory 1032, a static memory 1034, or other memory, and a storage unit 1036, both accessible to the processors 1010 such as via the bus 1002. The storage unit 1036 and memory 1032, 1034 store instructions 1016 embodying any one or more of the functions described herein. The memory/storage 1030 may also store temporary, intermediate, and/or long-term data for processors 1010. The instructions 1016 may also reside, completely or partially, within the memory 1032, 1034, within the storage unit 1036, within at least one of the processors 1010 (for example, within a command buffer or cache memory), within memory at least one of I/O components 1050, or any suitable combination thereof, during execution thereof. Accordingly, the memory 1032, 1034, the storage unit 1036, memory in processors 1010, and memory in I/O components 1050 are examples of machine-readable media.

As used herein, “machine-readable medium” refers to a device able to temporarily or permanently store instructions and data that cause machine 1000 to operate in a specific fashion, and may include, but is not limited to, random-access memory (RAM), read-only memory (ROM), buffer memory, flash memory, optical storage media, magnetic storage media and devices, cache memory, network-accessible or cloud storage, other types of storage and/or any suitable combination thereof. The term “machine-readable medium” applies to a single medium, or combination of multiple media, used to store instructions (for example, instructions 1016) for execution by a machine 1000 such that the instructions, when executed by one or more processors 1010 of the machine 1000, cause the machine 1000 to perform and one or more of the features described herein. Accordingly, a “machine-readable medium” may refer to a single storage device, as well as “cloud-based” storage systems or storage networks that include multiple storage apparatus or devices. The term “machine-readable medium” excludes signals per se.

The I/O components 1050 may include a wide variety of hardware components adapted to receive input, provide output, produce output, transmit information, exchange information, capture measurements, and so on. The specific I/O components 1050 included in a particular machine will depend on the type and/or function of the machine. For example, mobile devices such as mobile phones may include a touch input device, whereas a headless server or IoT device may not include such a touch input device. The particular examples of I/O components illustrated in FIG. 10 are in no way limiting, and other types of components may be included in machine 1000. The grouping of I/O components 1050 are merely for simplifying this discussion, and the grouping is in no way limiting. In various examples, the I/O components 1050 may include user output components 1052 and user input components 1054. User output components 1052 may include, for example, display components for displaying information (for example, a liquid crystal display (LCD) or a projector), acoustic components (for example, speakers), haptic components (for example, a vibratory motor or force-feedback device), and/or other signal generators. User input components 1054 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 1050 may include biometric components 1056, motion components 1058, environmental components 1060, and/or position components 1062, among a wide array of other physical sensor components. The biometric components 1056 may include, for example, components to detect body expressions (for example, facial expressions, vocal expressions, hand or body gestures, or eye tracking), measure biosignals (for example, heart rate or brain waves), and identify a person (for example, via voice-, retina-, fingerprint-, and/or facial-based identification). The motion components 1058 may include, for example, acceleration sensors (for example, an accelerometer) and rotation sensors (for example, a gyroscope). The environmental components 1060 may include, for example, illumination sensors, temperature sensors, humidity sensors, pressure sensors (for example, a barometer), acoustic sensors (for example, a microphone used to detect ambient noise), proximity sensors (for example, infrared sensing of nearby objects), and/or other components that may provide indications, measurements, or signals corresponding to a surrounding physical environment. The position components 1062 may include, for example, location sensors (for example, a Global Position System (GPS) receiver), altitude sensors (for example, an air pressure sensor from which altitude may be derived), and/or orientation sensors (for example, magnetometers).

The I/O components 1050 may include communication components 1064, implementing a wide variety of technologies operable to couple the machine 1000 to network(s) 1070 and/or device(s) 1080 via respective communicative couplings 1072 and 1082. The communication components 1064 may include one or more network interface components or other suitable devices to interface with the network(s) 1070. The communication components 1064 may include, for example, components adapted to provide wired communication, wireless communication, cellular communication, Near Field Communication (NFC), Bluetooth communication, Wi-Fi, and/or communication via other modalities. The device(s) 1080 may include other machines or various peripheral devices (for example, coupled via USB).

In some examples, the communication components 1064 may detect identifiers or include components adapted to detect identifiers. For example, the communication components 1064 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 1064, such as, but not limited to, geo-location via Internet Protocol (IP) address, location via Wi-Fi, cellular, NFC, Bluetooth, or other wireless station identification and/or signal triangulation.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein.

Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A system comprising:
a processor; and
a memory in communication with the processor, the memory comprising executable instructions that, when executed by the processor, cause the system to perform functions of:
predicting, by one or more processors of a robotic system and prior to execution of a robot action, at least one of an expected human behavior or an expected environmental change associated with a future execution of the robot action, the predicting being performed using a belief-space representation of the human or environment;
initiating partial execution of the robot action by the robotic system;
sensing, during the partial execution of the robot action, at least one of an observed human behavior or an observed environmental change using one or more sensors of the robotic system;
inferring, by the one or more processors, an alignment between the predicted human behavior or environmental change and the sensed human behavior or environmental change;
determining, based on the inferred alignment, whether a confidence condition associated with the robot action is satisfied; and
performing at least one of:
continuing execution of the robot action, based on determining that the confidence condition is satisfied; or
adapting the robot action by modifying at least one of a motion trajectory, timing, force, orientation, communication, or execution sequence of the robot action based on determining that the confidence condition is not satisfied.

2. The system of claim 1, wherein the memory further includes executable instructions that cause the system to perform functions of:
prior to performing the at least one of continuing execution or adapting the robot action, computing a predictive environmental stability metric representing a likelihood that the environment will remain within a predefined safety envelope during continued execution of the robot action, the predictive environmental stability metric being derived from the belief-space representation; and
modifying the determination of whether the confidence condition is satisfied based on the predictive environmental stability metric, such that continued execution of the robot action is permitted only when both the inferred alignment and the predictive environmental stability metric satisfy respective thresholds.

3. The system of claim 1, wherein the memory further includes executable instructions that cause the system to perform functions of:
prior to performing a transition between robot behaviors associated with the robot action, performing an active semantic search operation configured to reduce uncertainty in the belief-space representation by selectively gathering additional sensor data; and
updating the belief-space representation based on the additional sensor data before determining whether the confidence condition associated with the robot action is satisfied.

4. The system of claim 1, wherein the robot action is selected from a plurality of behavior nodes defined in a semantic belief behavior graph, each node corresponding to a distinct robot behavior, and wherein transitions between the plurality of behavior nodes are governed by edges representing belief-conditioned transition criteria based at least in part on the inferred alignment and the confidence condition.

5. The system of claim 1, wherein predicting the at least one of the expected human behavior or the expected environmental change comprises:
applying a theory-of-mind model to generate a belief-space representation of human readiness, the belief-space representation including an estimated internal state of a human interacting with the robotic system; and
updating the belief-space representation of human readiness based on the sensed human behavior during the partial execution of the robot action.

6. The system of claim 1, wherein the memory further includes executable instructions that cause the system to perform functions of:
recording an outcome of the robot action after completion or adaptation of the robot action;
computing a prediction accuracy metric representing a degree of correspondence between the predicted human behavior or environmental change and the sensed human behavior or environmental change; and
updating at least one parameter of the belief-space representation based on the prediction accuracy metric to refine future predictions associated with subsequent robot actions.

7. The system of claim 1, wherein inferring the alignment between the predicted human behavior or environmental change and the sensed human behavior or environmental change comprises:
computing a quantitative divergence metric between a predicted state distribution and an observed state distribution in the belief-space representation; and
determining whether the confidence condition is satisfied comprises comparing the quantitative divergence metric to a predefined adaptive threshold that varies based on at least one of task criticality, environmental risk level, or interaction context.

8. A method for adaptive robotic interaction, comprising:
predicting, by one or more processors of a robotic system and prior to execution of a robot action, at least one of an expected human behavior or an expected environmental change associated with a future execution of the robot action, the predicting being performed using a belief-space representation of the human or environment;
initiating partial execution of the robot action by the robotic system; sensing, during the partial execution of the robot action, at least one of an observed human behavior or an observed environmental change using one or more sensors of the robotic system;
inferring, by the one or more processors, an alignment between the predicted human behavior or environmental change and the sensed human behavior or environmental change;
determining, based on the inferred alignment, whether a confidence condition associated with the robot action is satisfied; and
performing at least one of:
continuing execution of the robot action, based on determining that the confidence condition is satisfied; or
adapting the robot action by modifying at least one of a motion trajectory, timing, force, orientation, communication, or execution sequence of the robot action based on determining that the confidence condition is not satisfied.

9. The method of claim 8, wherein the memory further includes executable instructions that cause the system to perform functions of:
prior to performing the at least one of continuing execution or adapting the robot action, computing a predictive environmental stability metric representing a likelihood that the environment will remain within a predefined safety envelope during continued execution of the robot action, the predictive environmental stability metric being derived from the belief-space representation; and
modifying the determination of whether the confidence condition is satisfied based on the predictive environmental stability metric, such that continued execution of the robot action is permitted only when both the inferred alignment and the predictive environmental stability metric satisfy respective thresholds.

10. The method of claim 8, wherein the memory further includes executable instructions that cause the system to perform functions of:
prior to performing a transition between robot behaviors associated with the robot action, performing an active semantic search operation configured to reduce uncertainty in the belief-space representation by selectively gathering additional sensor data; and
updating the belief-space representation based on the additional sensor data before determining whether the confidence condition associated with the robot action is satisfied.

11. The method of claim 8, wherein the robot action is selected from a plurality of behavior nodes defined in a semantic belief behavior graph, each node corresponding to a distinct robot behavior, and wherein transitions between the plurality of behavior nodes are governed by edges representing belief-conditioned transition criteria based at least in part on the inferred alignment and the confidence condition.

12. The method of claim 8, wherein predicting the at least one of the expected human behavior or the expected environmental change comprises:
applying a theory-of-mind model to generate a belief-space representation of human readiness, the belief-space representation including an estimated internal state of a human interacting with the robotic system; and
updating the belief-space representation of human readiness based on the sensed human behavior during the partial execution of the robot action.

13. The method of claim 8, wherein the memory further includes executable instructions that cause the system to perform functions of:
recording an outcome of the robot action after completion or adaptation of the robot action;
computing a prediction accuracy metric representing a degree of correspondence between the predicted human behavior or environmental change and the sensed human behavior or environmental change; and
updating at least one parameter of the belief-space representation based on the prediction accuracy metric to refine future predictions associated with subsequent robot actions.

14. The method of claim 8, wherein inferring the alignment between the predicted human behavior or environmental change and the sensed human behavior or environmental change comprises:
computing a quantitative divergence metric between a predicted state distribution and an observed state distribution in the belief-space representation; and
determining whether the confidence condition is satisfied comprises comparing the quantitative divergence metric to a predefined adaptive threshold that varies based on at least one of task criticality, environmental risk level, or interaction context.

15. A non-transitory computer readable medium on which are stored instructions that when executed cause a programmable device to:
predicting, by one or more processors of a robotic system and prior to execution of a robot action, at least one of an expected human behavior or an expected environmental change associated with a future execution of the robot action, the predicting being performed using a belief-space representation of the human or environment;
initiating partial execution of the robot action by the robotic system; sensing, during the partial execution of the robot action, at least one of an observed human behavior or an observed environmental change using one or more sensors of the robotic system;
inferring, by the one or more processors, an alignment between the predicted human behavior or environmental change and the sensed human behavior or environmental change;
determining, based on the inferred alignment, whether a confidence condition associated with the robot action is satisfied; and
performing at least one of:
continuing execution of the robot action, based on determining that the confidence condition is satisfied; or
adapting the robot action by modifying at least one of a motion trajectory, timing, force, orientation, communication, or execution sequence of the robot action based on determining that the confidence condition is not satisfied.

16. The non-transitory computer readable medium of claim 15, further including instructions that when executed cause a programmable device to:
prior to performing the at least one of continuing execution or adapting the robot action, compute a predictive environmental stability metric representing a likelihood that the environment will remain within a predefined safety envelope during continued execution of the robot action, the predictive environmental stability metric being derived from the belief-space representation; and
modify the determination of whether the confidence condition is satisfied based on the predictive environmental stability metric, such that continued execution of the robot action is permitted only when both the inferred alignment and the predictive environmental stability metric satisfy respective thresholds.

17. The non-transitory computer readable medium of claim 15, further including instructions that when executed cause a programmable device to:
prior to performing a transition between robot behaviors associated with the robot action, perform an active semantic search operation configured to reduce uncertainty in the belief-space representation by selectively gathering additional sensor data; and
update the belief-space representation based on the additional sensor data before determining whether the confidence condition associated with the robot action is satisfied.

18. The non-transitory computer readable medium of claim 15, wherein the robot action is selected from a plurality of behavior nodes defined in a semantic belief behavior graph, each node corresponding to a distinct robot behavior, and wherein transitions between the plurality of behavior nodes are governed by edges representing belief-conditioned transition criteria based at least in part on the inferred alignment and the confidence condition.

19. The non-transitory computer readable medium of claim 15, wherein predicting the at least one of the expected human behavior or the expected environmental change comprises:
applying a theory-of-mind model to generate a belief-space representation of human readiness, the belief-space representation including an estimated internal state of a human interacting with the robotic system; and
updating the belief-space representation of human readiness based on the sensed human behavior during the partial execution of the robot action.

20. The non-transitory computer readable medium of claim 15, further including instructions that when executed cause a programmable device to:
record an outcome of the robot action after completion or adaptation of the robot action;
compute a prediction accuracy metric representing a degree of correspondence between the predicted human behavior or environmental change and the sensed human behavior or environmental change; and
update at least one parameter of the belief-space representation based on the prediction accuracy metric to refine future predictions associated with subsequent robot actions.
